(19) United States
(12) Patent Application Publication
(10) Pub. No.: US 2024/0416341 A1
(43) Pub. Date: Dec. 19, 2024

(54) Fluidic Device With Capillary Barrier

(71) Applicant: Purigen Biosystems, Inc., Pleasanton, CA (US)

(72) Inventors: Sean Arin, Pleasanton, CA (US); Tony Makarewicz, Pleasanton, CA (US); Lewis Marshall, Pleasanton, CA (US); Klint Rose, Pleasanton, CA (US)

(21) Appl. No.: 18/706,989

(22) PCT Filed: Nov. 23, 2022
(86) PCT No.: PCT/US2022/050961

§ 371 Date: May 2, 2024

Related U.S. Application Data
(60) Provisional application No. 63/264,542, filed on Nov. 24, 2021.

(51) Int. Cl. B01L 3/00; G01N 27/447

(52) U.S. Cl. CPC B01L 3/50273; G01N 27/44791; B01L 2300/047; B01L 2300/0645; B01L 2300/0829; B01L 2300/0851; B01L 2300/161; B01L 2400/049; B01L 2400/0688

(57) ABSTRACT

Provided herein is a fluidic device comprising a capillary barrier. A notch capillary barrier comprises two opposing ramps separated by a notch, optionally within a plateau region. An inset capillary barrier comprises a notch introduced into a wall of the fluidic channel. Such capillary barriers are useful for arresting menisci of liquids flowing through channels in which the capillary barriers are disposed. Liquids arrested on two sides of a notch face in a capillary barrier can be placed into fluid contact by application of negative pressure to the notch area sufficient to overcome the burst pressure on each side of the capillary barrier.

### CROSS-REFERENCE-TO RELATED APPLICATIONS

This application is a U.S. National Stage Application of PCT Application No. PCT/US2022/050961 filed on Nov. 23, 2022, which application claims the benefit of U.S. Provisional Application No. 63/264,542, filed on Nov. 24, 2021, the disclosures of which applications are incorporated herein by reference in its entirety.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Microfluidic devices are devices comprising at least one fluidic channel having a cross-sectional aspect in at least one part of the channel of no more than about 1 mm. Generally, microfluidic devices are used to move molecular analytes from one point in a fluidic circuit to another. This can be useful to separate analytes from one another for analysis, and put analytes in contact with chemicals for performing chemical or biochemical reactions. In certain instances, analytes can flow through bulk fluid flow, that is, by moving fluid containing the analytes through the channels. Such movement typically requires pumping mechanisms. In other instances, analytes having an ionic charge can be moved by setting up a voltage gradient along the length of a fluidic channel, and moving the analytes by electric force. This method is used, for example, in electrophoresis and isotachophoresis (“ITP”). In this case, fluidic circuits are filled with fluid so that an electrical connection can be made between two electrodes positioned at different points in the circuit.

In both bulk flow methods and electrical methods, control of fluid flow is generally important for proper operation or preparation of the device. In certain versions of ITP, a buffered solution containing trailing electrolytes, a sample solution containing analytes, and a buffered solution containing leading electrolytes are properly positioned within the fluidic circuit so that analyte can be focused between the trailing and leading electrolytes. Fluid flow within a fluidic circuit can be controlled by various types of microfluidic valves. Microfluidic valves can be active or passive. Generally, active valves require a mechanical element that is externally activated to open and close the microvalve. An exemplary active valve is a diaphragm valve, in which a flexible diaphragm can be actuated to close or open a fluidic channel. Passive microvalves are valves for which the operational state, i.e. open or closed, is determined by the fluid they control. An exemplary passive valve is a hydrophobic valve that controls the flow of liquid through a change in hydrophobicity of a surface in the lumen of a fluidic channel. Another passive valve is a capillary valve, also referred to as a capillary barrier, that relies on capillary pressure control the flow of liquid in a channel.

Capillary barriers can be structures in fluidic conduits that use capillary forces to regulate the flow the fluids, e.g., liquids, across the capillary barrier. Capillary barriers can create microfluidic structures in a fluidic channel, for example, by narrowing a channel dimension to less than one millimeter. Capillary forces can be applied, for example, through changes in hydrophobicity and changes in conduit geometry. For example, changes in the cross-sectional area of a fluidic conduit, such as increases or decreases in cross-sectional area, can impose capillary forces on fluids flowing through the channel. In this way capillary barriers can slow or halt the movement of fluids, until a countervailing force, for example, gas pressure, overcomes the force of the capillary barrier. The amount of force necessary to overcome the force of a capillary barrier is sometimes referred to as the “burst pressure.” A capillary barrier can be said to “pin” a meniscus of a fluid at the capillary barrier.

### SUMMARY

The current disclosure provides, in some aspects, fluidic device comprising a notch capillary barrier or an inset barrier disposed in a fluidic channel comprising, wherein: the notch capillary barrier comprises a first ramp and a second ramp, wherein the first and second ramps rise in opposite directions within the fluidic channel, and a notch positioned between the first and second ramps, wherein the notch comprises a base and two opposing faces; and the inset barrier comprises first and second base sections within the fluidic channel, and a notch positioned between the first and second base sections, wherein the notch comprises a notch base and two opposing faces.

The current disclosure provides, in some aspects, fluidic device comprising a notch capillary barrier disposed in a fluidic channel comprising, wherein the notch capillary barrier comprises a first ramp and a second ramp, wherein the first and second ramps rise in opposite directions within the fluidic channel, and a notch positioned between the first and second ramps, wherein the notch comprises a base and two opposing faces. The current disclosure provides, in some aspects, fluidic device comprising an inset barrier disposed in a fluidic channel comprising, wherein the inset barrier comprises first and second base sections within the fluidic channel, and a notch positioned between the first and second base sections, wherein the notch comprises a notch base and two opposing faces.

In some cases, the fluidic channel at the base of the first ramp has a width or height between about 30 μm and about 50 μm, corresponding to a cross-sectional area between about 900 μm² and about 2500 μm². In some cases, the first ramp and/or the second ramp have a rise-over-run between 0.4 and 0.9. In some cases, the first ramp and/or the second ramp have a rise-over-run between about 0.5 and about 1. In some cases, the first ramp and/or the second ramp have a rise-over-run between about 1 and about 1.732. In some cases, rise-over-run of the first ramp is greater than the rise-over-run of the second ramp. In some cases, the first ramp and/or the second ramp are configured as an angled plane. In some cases, the first ramp and/or the second ramp are curved. In some cases, the notch capillary barrier comprises a cross-sectional area in a longitudinal axis of the channel of triangular shape comprising a notch. In some cases, the notch capillary barrier comprises a plateau between the first ramp and the second ramp, and the notch is located within the plateau. In some cases, the capillary barrier extends transversely across the width of the fluidic channel. In some cases, the base of the notch is positioned higher than a base of the channel. In some cases, each notch forms an edge with one of the ramps or a plateau positioned between the ramps, wherein the edge is straight. In some cases, each notch forms an edge with one of the ramps or a plateau positioned between the ramps, wherein the edge is curved. In some cases, the curve is convex relative to the ramp. In some cases, the edges are parallel or oblique with respect to each other. In some cases, the faces of the notch are oriented in a Z dimension and notch comprises an expansion of a wall of the channel in an X-Y plane. In some cases, the notch has a notch depth from an edge of about 0.05 mm. In some cases, the space between the channel wall and the notch base is about 0.15 mm. In some cases, the angle of the first ramp is about 10 degrees, at least about 15 degrees, or at least about 20 degrees steeper than the angle of the second ramp. In some cases, the first ramp has an angle of about 28.9°. In some cases, one or both of the notch faces are configured as a flat plane. In some cases, one or both notch faces are configured as a curved plane. In some cases, the plateau, when present, is about parallel to a base of the fluidic channel. In some cases, the notch faces, notch base and channel walls define a notch space, and the fluidic device comprises a gas line communicating between a pneumatic port and a port opening into the notch space. In some cases, the fluidic channel comprises a plurality of notch capillary barriers, and wherein a single pneumatic port communicates through a plurality of gas lines with ports opening into each of the notch spaces. In some cases, the notch or inset capillary barrier has a gap (h5) between the top of the plateau and the opposing wall from about 100 μm to about 150 μm. In some cases, the notch or inset capillary barrier has a gap (h5) between the top of the plateau and the opposing wall from about 50 μm to about 400 μm. In some cases, the disclosed the notch capillary barrier comprises a buffer having a surface tension from about 60 mN/m to about 70 mN/m. In some cases, the notch capillary barrier comprises a buffer comprising a surfactant. In some cases, the notch capillary barrier comprises a buffer comprising Tris-Chloride ranging from 10 mM to 100 mM. In some cases, the notch of the inset barrier has a depth between about 30 μm and 50 μm. In some cases, the faces of the inset barrier have different heights. In some cases, the fluidic device further comprises a gas line communicating between a pneumatic port and a port opening into a notch/inset space in the notch/inset barrier.

The current disclosure provides, in some aspects, a fluidic circuit comprising: a) a first reservoir; b) a sample channel communicating with the first reservoir; c) an isotachophoresis (“ITP”) channel communicating with the sample channel; d) a first circuit branch communicating with the ITP channel and comprising a second reservoir and a third reservoir, and positioned between them, a first notch/inset capillary barrier; e) a second circuit branch, comprising (i) an elution channel communicating with the ITP channel, and positioned between them, a second notch/inset capillary barrier, and (ii) a fourth reservoir communicating with the elution channel and communicating with a fifth reservoir, and positioned between them, a third notch/inset capillary barrier. In some cases, the first reservoir is a trailing electrolyte reservoir. In some cases, the second reservoir is a leading electrolyte reservoir. In some cases, the third reservoir is a higher ionic strength leading electrolyte reservoir. In some cases, the fourth reservoir is an elution buffer reservoir. In some cases, the fifth reservoir is a higher ionic strength elution buffer reservoir.

The current disclosure provides, in some aspects, a fluidic device comprising a fluidic circuit comprising: a) a trailing electrolyte reservoir; b) a sample channel communicating with the trailing electrolyte reservoir and, positioned between them, a first cliff capillary barrier, wherein a face of the first cliff capillary barrier faces the trailing electrolyte reservoir; c) an isotachophoresis (“ITP”) channel communicating with the sample channel and, positioned between them, a second cliff capillary barrier, wherein a face of the second capillary barrier faces the sample channel; d) a first circuit branch communicating with the ITP channel and comprising a leading electrolyte reservoir and a higher ionic strength leading electrolyte reservoir, and positioned between them, a first notch capillary barrier. In some instances, the disclosed fluidic device further comprises e) a second circuit branch, comprising (i) an elution channel communicating with the ITP channel, and positioned between them, a second notch capillary barrier, (ii) an elution buffer reservoir communicating with the elution channel and communicating with a higher ionic strength elution buffer reservoir, and positioned between them, a third notch capillary barrier. In some instances, the disclosed fluidic device further comprises one or more pneumatic ports communicating through one or more gas lines with ports opening onto spaces defined by the notch. In some instances, the disclosed fluidic device further comprises one or more pneumatic ports each communicating with a cliff capillary barrier through a gas line opening into a space adjacent to the cliff face of the cliff capillary barrier. In some instances, the disclosed fluidic device further comprises a sample well positioned over the sample channel and communicating through a bore therewith. In some cases, the sample channel communicates with a sample reservoir positioned over the sample channel.

In some cases, the sample reservoir comprises (a) an entryway for ambient air at one end and (b) an aperture that penetrates said substrate at another end of said loading reservoir, wherein said first reservoir has a frustoconical shape with a wider region of said frustoconical shape positioned at said entryway for ambient air and a narrower region positioned at said first aperture that penetrates said substrate. In some cases, the sample reservoir is closed by a removable material. In some cases, the disclosed fluidic device comprises a plurality, e.g., eight, of the fluidic circuits. In some cases, the reservoirs of the fluidic circuits are aligned with wells of 96-well plate having dimensions about 127.76 mm×about 85.48 mm.

In some instances, the disclosed fluidic device further comprises (i) a first substrate having a first face and a second face, wherein said first face comprises the reservoirs configured as hollow tubes that create a through hole between the first face and the second face, and the second face comprises the gas lines and the channels configured as grooves in the second face, and the capillary barriers configured as raised elements within the groups including said first channel; and (ii) a second substrate bonded to the second phase of the first substrate where in the second substrate closes the reservoirs, the gas lines in the channels. In some instances, the disclosed fluidic device further comprises a cover plate covering the first face of the first substrate. In some instances, the disclosed fluidic device further comprises a gasket sandwiched between the cover letter and the first substrate. In some instances, the disclosed fluidic device further comprises a hydrophobic membrane sandwiched between the cover layer and the first substrate, optionally between the cover layer in the gasket, wherein the hydrophobic membrane and the gasket cover the pneumatic ports. In some cases, the first substrate comprises a plastic, e.g., polytetrafluoroethylene (PTFE).

The current disclosure provides, in some aspects, a system comprising: a) an instrument comprising: i) a cartridge interface configured to engage a fluidic device, and comprising: (I) a plurality of electrodes, each electrode configured to be positioned within a buffer reservoir in an engaged fluidic device, and (II) a plurality of pneumatic ports, each pneumatic port configured to engage a pneumatic port in an engaged fluidic device; ii) a voltage source communicating with the plurality of electrodes, and configured to apply a voltage difference between the electrodes; and iii) a source of positive and/or negative pressure communicating with the pneumatic ports; and b) a fluidic device disclosed herein, engaged with the cartridge interface. In some cases, the fluidic device is loaded with: i) a trailing electrolyte buffer (“TE”) solution in the trailing electrolyte reservoir, ii) a leading electrolyte buffer (“LE”) solution in a leading electrolyte reservoir, wherein leading electrolyte ions in the LE solution have greater mobility than trailing electrolyte ions in the TE; iii) a higher ionic strength leading electrolyte buffer (“LEH”) solution in the higher concentration leading electrolyte buffer reservoir, wherein the LEH solution has a higher ionic strength than the LE solution; iv) an elution buffer (“EE”) solution in the elution reservoir, wherein leading electrolyte ions in the EE solution are present at a lower concentration than in the LE solution; and v) a higher ionic strength elution buffer (“EH”) solution in the higher ionic strength elution buffer reservoir, wherein leading electrolyte ion in the EH solution is present at a higher concentration than in the EE solution; and/or vi) a sample solution into the sample channel. In some instances, the instrument further comprises: iv) a temperature sensor configured to measure temperature in a fluidic channel of an engaged fluidic device. In some instances, the instrument further comprises: iv) an infrared temperature sensor configured to measure temperature in a fluidic channel of an engaged fluidic device.

The current disclosure provides, in some aspects, a method of fluidically connecting a first liquid and a second liquid in a fluidic circuit of a fluidic device, comprising: a) providing a fluidic device comprising a fluidic circuit comprising a first reservoir and a second reservoir communicating through a fluidic channel, and, positioned in the fluidic channel, a notch capillary barrier or an inset capillary barrier; b) providing a first liquid to the first reservoir and a second liquid to the second reservoir; and c) applying positive or negative pressure to the fluidic channel in excess of the burst pressure of the notch capillary barrier, and sufficient to fluidically connect the first liquid and the second liquid. In some cases, the pressure comprises vacuum pressure. In some cases, the fluidic device further comprises a pneumatic ports communicating through one or more gas lines with ports opening onto spaces defined by the notch, and the vacuum pressure is applied through the pneumatic port.

The current disclosure provides, in some aspects, a method of fluidically connecting fluids in a fluidic circuit, comprising: a) providing a fluidic device disclosed herein; b) loading fluids into the fluidic device by: i) introducing a trailing electrolyte buffer (“TE”) solution into the trailing electrolyte reservoir, ii) introducing a leading electrolyte buffer (“LE”) solution into a leading electrolyte reservoir, wherein leading electrolyte ions in the LE solution have greater mobility than trailing electrolyte ions in the TE; iii) introducing a higher ionic strength leading electrolyte buffer (“LEH”) solution into the higher concentration leading electrolyte buffer reservoir, wherein the LEH solution has a higher ionic strength than the LE solution; iv) introducing an elution buffer (“EE”) solution into the elution reservoir, wherein leading electrolyte ions in the EE solution are present at a lower concentration than in the LE solution; and v) introducing a higher ionic strength elution buffer (“EH”) solution into the higher ionic strength elution buffer reservoir, wherein leading electrolyte ion in the EH solution is present at a higher concentration than in the EE solution; c) applying positive or negative pressure at the first and second cliff capillary barriers to arrest TE solution at the first cliff capillary barrier, and to arrest LE solution at the second cliff capillary barrier; d) introducing a sample solution into the sample channel, wherein the sample solution has sufficiently low surface tension to allow the sample solution to create liquid contact the TE solution at the first cliff capillary barrier, and the LE solution at the second cliff capillary barrier; and e) applying vacuum pressure at the first, second and third notch capillary barriers sufficient to overcome the burst pressures of the first, second, and third notch capillary barriers, wherein i) the LEH solution and the LE solution, ii) the EE solution and the LE solution, and the EE solution and the EH solution are put into liquid contact with each other at the first, second, and third notch capillary barriers respectively. In some cases, the pressure comprises vacuum. In some cases, the disclosed method further comprises f) introducing an electrode into one or more of the reservoirs. In some cases, the disclosed method further comprises g) applying a voltage or current across said first electrode and second electrode. In some cases, the disclosed method further comprises h) inserting a third electrode into second elution buffer in said second elution buffer reservoir; and, after operation (h), applying a voltage or current across said first and third electrode, and, optionally, reducing current of said second electrode. In some cases, an electrode in the trailing electrolyte reservoir is an anode, and the electrodes in the leading electrolyte reservoir and/or elution electrolyte reservoir is/are cathodes.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 shows an exploded view of an exemplary fluidic device.

FIG. 2 shows an exemplary ITP circuit.

FIG. 3 shows an exemplary ITP circuit loaded with buffers and a sample.

FIGS. 4A and 4B show a top-down and longitudinal side view of an exemplary cliff capillary barrier.

FIGS. 5A and 5B show a top-down and longitudinal side view of an exemplary plateau capillary barrier.

FIGS. 6A, 6B and 6C show a top-down, isometric and longitudinal side view of an exemplary notch capillary barrier.

FIG. 7 shows lateral side view of an exemplary notch capillary barrier.

FIGS. 8A, 8B and 8C show pinning of menisci of liquids in an exemplary notch capillary barrier.

FIGS. 9A and 9B show a top-down and a longitudinal side view of an exemplary inset capillary barrier.

FIGS. 10A, 10B, 10C and 10D show four types of capillary barriers, the “ramp” or “plateau” barrier, the “cliff” barrier, the “notch” barrier and the “inset” barrier, respectively.

FIG. 11 shows a comparison of performance for notch capillary barriers vs. ramp barriers.

FIG. 12A and FIG. 12B show an example of a fluidic device having multiple notch barriers. FIG. 12C shows an example of a gas line in a fluidic device.

### DETAILED DESCRIPTION

The following embodiments are described in sufficient detail to enable those skilled in the art to make and use the invention. It is to be understood that other embodiments would be evident based on the present disclosure, and that system, process, or mechanical changes can be made without departing from the scope of an embodiment of the present disclosure.

In the following description, numerous specific details are given to provide a thorough understanding of the invention. However, it will be apparent that the invention can be practiced without these specific details. In order to avoid obscuring an embodiment of the present disclosure, some well-known techniques, system configurations, and process steps are not disclosed in detail. Throughout this disclosure, various publications, patents and published patent specifications are referenced by an identifying citation. The disclosures of these publications, patents and published patent specifications are hereby incorporated by reference into the present disclosure to more fully describe the state of the art to which this invention pertains.

### Definitions

These and other valuable aspects of the embodiments of the present disclosure consequently further the state of the technology to at least the next level. While the disclosure has been described in conjunction with a specific best mode, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Use of absolute or sequential terms, for example, “will,” “will not,” “shall,” “shall not,” “must,” “must not,” “first,” “initially,” “next,” “subsequently,” “before,” “after,” “lastly,” and “finally,” are not meant to limit scope of the present embodiments disclosed herein but as exemplary.

As used herein, “or” may refer to “and”, “or,” or “and/or” and may be used both exclusively and inclusively. For example, the term “A or B” may refer to “A or B”, “A but not B”, “B but not A”, and “A and B”. In some cases, context may dictate a particular meaning.

Any systems, methods, software, and platforms described herein are modular and not limited to sequential steps. Accordingly, terms such as “first” and “second” do not necessarily imply priority, order of importance, or order of acts.

As used herein, the term “about” when referring to a number or a numerical range means that the number or numerical range referred to is an approximation within experimental variability (or within statistical experimental error), and the number or numerical range may vary from, for example, from 1% to 10% of the stated number or numerical range. Unless otherwise indicated by context, the term “about” refers to +10% of a stated number or value.

As used herein, the term “approximately” means within an acceptable error range for the particular value as determined by one of ordinary skill in the art, which will depend in part on how the value is measured or determined, e.g., the limitations of the measurement system. For example, “approximately” can mean within 1 or more than 1 standard deviation, per the practice in the given value. Where particular values are described in the application and claims, unless otherwise stated the term “approximately” should be assumed to mean an acceptable error range for the particular value.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

All ranges disclosed herein also encompass any and all possible sub-ranges and combinations of sub-ranges thereof. Any listed range can be recognized as sufficiently describing and enabling the same range being broken down into at least equal halves, thirds, quarters, fifths, tenths, and so forth. As a non-limiting example, each range discussed herein can be readily broken down into a lower third, middle third and upper third, and the like. All language such as “up to,” “at least,” “greater than,” “less than,” and the like include the number recited and refer to ranges which can be subsequently broken down into sub-ranges as discussed above. Finally, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Whenever the term “at least,” “greater than,” “greater than or equal to”, or a similar phrase precedes the first numerical value in a series of two or more numerical values, the term “at least,” “greater than,” “greater than or equal to” or similar phrase applies to each of the numerical values in that series of numerical values. For example, “at least 1, 2, or 3” is equivalent to “at least 1, at least 2, and/or at least 3.”

Whenever the term “no more than,” “less than,” “less than or equal to,” “no greater than,” “at most” or a similar phrase, precedes the first numerical value in a series of two or more numerical values, the term “no more than,” “less than,” “less than or equal to,” “no greater than,” “at most,” or similar phrase applies to each of the numerical values in that series of numerical values. For example, “less than 3, 2, or 1” is equivalent to “less than 3, less than 2, and/or less than 1.”

### I. Fluidic Devices

### A. Overview

Fluidic devices typically include channels within which liquid can be flowed. They also can include other useful features. These include, for example, reservoirs that communicate with fluidic channels and into which liquids can be placed to move into fluidic channels. They can further include elements to control the flow of liquids, such as, valves. A common way of assembling a fluidic chip is to provide a substrate onto which various elements can be disposed. For example, fluidic channels can be created by introducing grooves into a surface on one side of a substrate, and eventually covering that surface to closed channels. Reservoirs can be formed from container-shaped elements, such as tubes or cones, on an opposite side of the substrate. Apertures between the two sides allows liquids introduced into a reservoir on one side to travel into fluidic channels on the opposite side. Capillary barriers can be present as features introduced onto the surface of a conduit in the substrate. Fluidic channels can be closed by covering the surface that comprises them with another substrate. The substrates can be of the same or of different materials. So, for example, both substrates can be comprised of polypropylene. Alternatively, the substrate comprising the features can be made of a hard plastic while the covering can be made of a plastic film. Where a fluidic device comprises two pieces that are to be fitted together, they may be provided with mechanical holding elements, such as snaps. Alternatively, they can be welded together, for example, through a heat seal.

Provided herein are devices comprising any of a variety of capillary barriers. The capillary barriers include, for example, a “plateau” or “ramp” barrier, a “cliff” barrier, a “notch” barrier, and a “inset” barrier. These barriers are useful for regulating the flow of liquids in fluidic channels comprising the barriers.

Embodiments of capillary barriers are described in, for example, U.S. Pat. No. 10,233,441 (Mar. 19, 2019; Santiago et al.), U.S. Pat. No. 10,415,030 (Sep. 17, 2019; Marshall et al.) and U.S. Patent Application Publication US 2019/0071661 (Mar. 7, 2019; Marshall et al.).

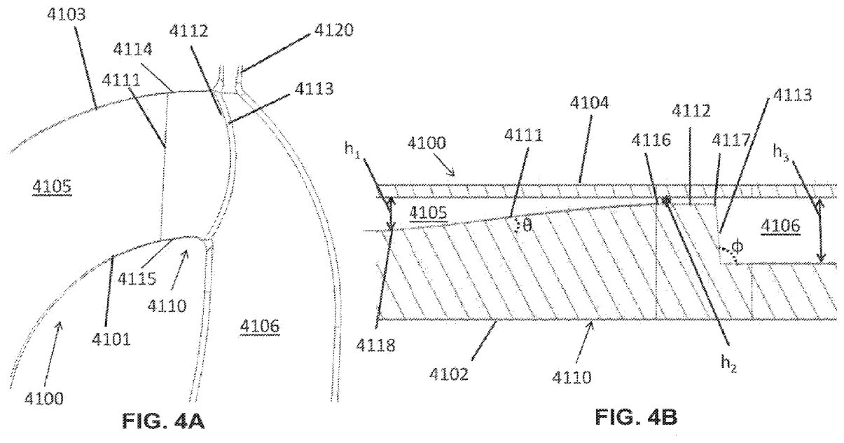

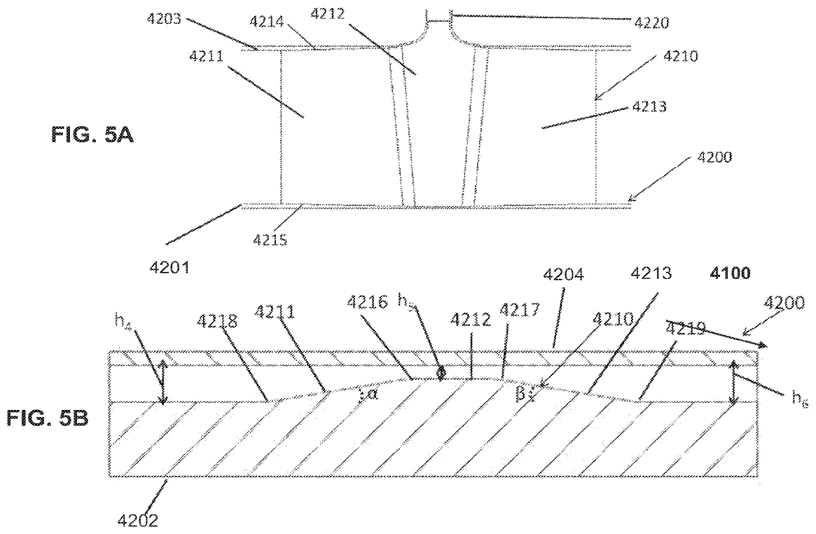

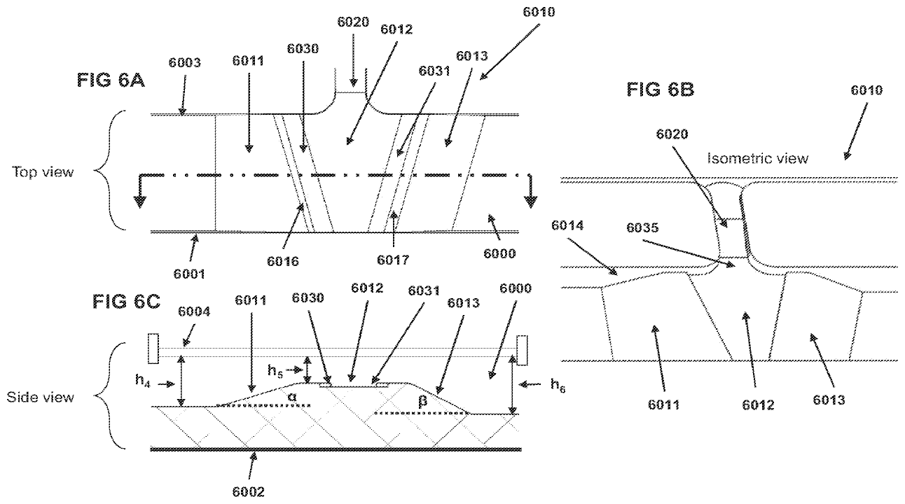

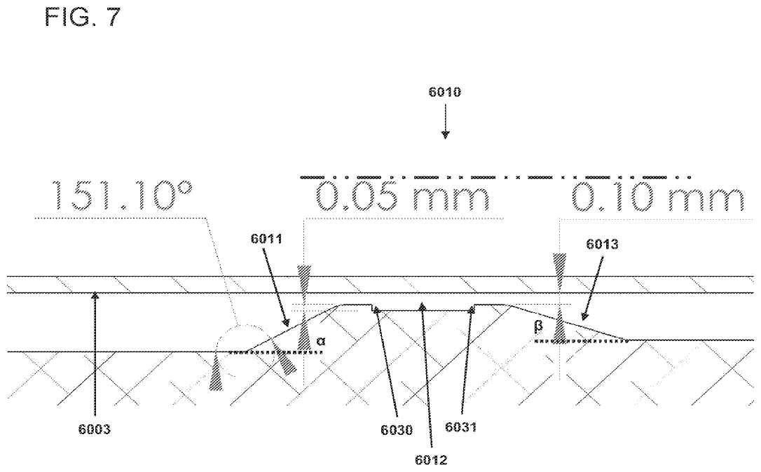

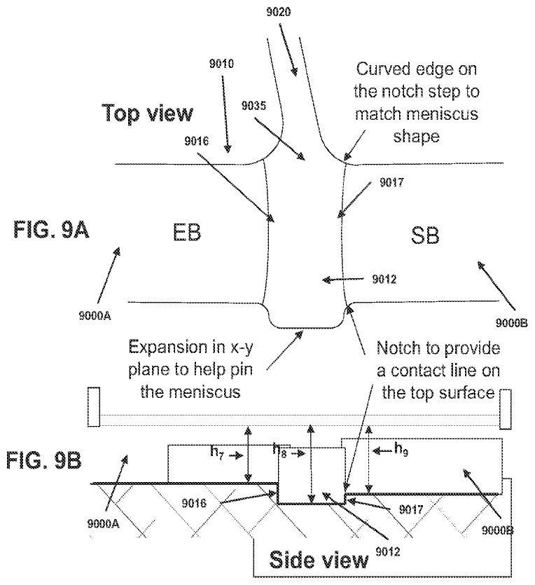

The burst pressure of a plateau or ramp capillary barrier can be primarily a function of the channel height where the fluids meet (h5 in FIG. 5B), as referred to as the gap (h5) between the top of the plateau and the opposing wall, or as the height of the barrier (or barrier height). Reducing the channel height can increase the burst pressure, or strength, of the capillary barrier. The burst pressure of a ramp, notch, or inset barrier may also depend on the height of the channel where the fluid is pinned. Generally, the smaller the height of the channel, the higher the burst pressure will be. These barriers may also take advantage of pinning the meniscus on at least one surface using a rapid expansion in the barrier geometry. Rapidly expanding the geometry on additional surfaces can further strengthen the barrier. The cliff barrier in FIG. 4 is an example of rapidly expanding the geometry vertically while also expanding horizontally to help pin the meniscus on 3 edges. The notch capillary barriers in FIG. 6 can take advantage of the vertical expansion to pin the meniscus, as well as an expansion along one horizontal edge (into the airline). The inset barrier can be designed to minimize intrusion of the barrier feature into the primary microfluidic channel. The rapid vertical expansion (or steps) can pin the meniscus on one surface, and horizontal expansions along both sides of the channel can provide two additional surfaces to pin the meniscus (FIG. 9).

A particularly useful capillary barrier has a design that pins a fluid on three edges and prevents it from protruding into the channel. This creates a strong barrier that avoids overflow. The angle that a cliff meets the sidewall can be important for pinning a fluid. Accordingly, in some embodiments, the cliff or notch meets the sidewall at an oblique, rather than perpendicular, angle.

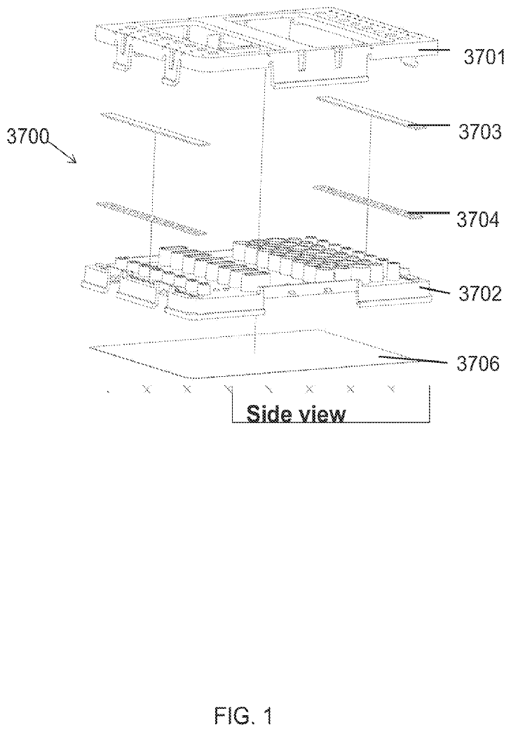

FIG. 1 shows an exploded perspective view of a multi-part fluidic device 3700. The fluidic device 3700 may comprise a cover piece or cover layer 3701, a chip plate or substrate 3702 typically made of a hydrophobic plastic, for example, polytetrafluoroethylene (“PTFE”), a hydrophobic membrane 3703, and a compressible gasket 3704. The hydrophobic membrane 3703 may comprise a strip of hydrophobic membrane 3703 disposed within and/or across the pneumatic ports 3705 and sandwiched between the cover 3701 and the substrate 3702. The compressible gasket 3704 may comprise a strip of gasket material comprising apertures which are shaped and spaced to correspond to the pneumatic ports 3705. The cover 3701 and the chip 3702 may comprise one or more mating features (e.g. snaps, interference fits, height standoffs, etc.) configured to couple the two pieces together as described herein. The mating features may be configured to apply force to the compressible gasket 3704 to seal the pneumatic ports 3705 as described herein. The cover 3701 may be configured to interface with a pneumatic device and/or other elements of an instrument, for example any of the instruments described herein. The device 3700 may further comprise a bottom layer of material 3706 that closes the channels. The chip 3702 may be manufactured such that three walls of the channels are formed on a bottom layer or underside of the chip 3702. The bottom layer of material 3706 may be coupled to the underside of the chip 3702 in order to form the fourth wall of the channels, thereby creating closed channels. The bottom layer of material 3706 may be coupled to the underside of the chip 3702 through the use of a solvent, heat, a solvent heat bond, pressure, adhesive bond, laser weld, or a combination thereof. For example, the material can be a heat seal which bonds to the chip surface through application of heat which partially melts the materials, thereby bonding them. In certain embodiments, bonding may be achieved through the use of a solvent which dissolves the materials, thereby causing them to flow together and bond.

Piece 3702 can be made from a variety of materials, including but not limited to, glass (e.g., borosilicate glass), silicon, plastic, and elastomer. Plastics can include polymethylmethacrylate (PMMA), cyclic olefin copolymer (COC), cyclic olefin polymer (COP), polyethylene, polyethylene terephthalate (PET), high-density polyethylene (HDPE), and low-density polyethylene (LDPE). Elastomers can include polydimethylsiloxane (PDMS). The chip or substrate may for example comprise a COC such as TOPAS 8007. The capillary barriers may be made from the same material(s) as the channel or a different material(s) as the channel.

In some embodiments, the bottom layer of material 3706 may comprise a cyclic olefin copolymer as described herein. For example, the bottom layer of material 3706 may comprise TOPAS® 8007.

Plastic pieces can be made by any known method, for example, injection molding, extrusion, blow molding, rotational molding, thermoforming, expanded bead foam molding and extruded foam molding, and 3D printing.

In some embodiments, bonding of the bottom layer of material 3706 to the underside of the chip 3702 may be achieved through the use of an organic solvent, for example toluene.

### B. Fluidic Circuits

Fluidic devices can comprise fluidic circuits. As used herein, the term “fluidic circuit” refers to a continuous fluidic passage. The fluidic passage can contain any relevant features including, for example, fluidic channels, capillary barriers and reservoirs that communicate with fluidic channels. Two points of a fluidic circuit are said to be in “fluidic communication” when liquid can travel through the circuit between the two points. Two points of a fluidic circuit are said to be in “fluid contact” or “liquid contact” when they are connected by an unbroken fluid or liquid path. Two points of a fluidic circuit are said to be in “electrical communication” when an electric current can be introduced between the two points, e.g., through a fluid in the circuit comprising an electrolyte. Two points of a fluidic circuit are said to be in “electrical contact” when current can flow between them.

Fluidic devices also can comprise pneumatic or gas lines that communicate between a pneumatic port in the fluidic device and a port entering onto the fluidic circuit. Such pneumatic lines can be used to introduce positive or negative pressure into the fluidic circuit. In some cases, the width of gas lines can be between 250-350 μm, depth can be smaller (e.g., about 60 μm, about 70 μm, about 80 μm, about 90 μm, about 100 μm, about 120 μm, or about 150 μm) near the barriers then increase to (e.g., about 200 μm, about 250 μm, about 275, about 300 μm, or about 325 μm) on the lines that connect to the edge of the chip.

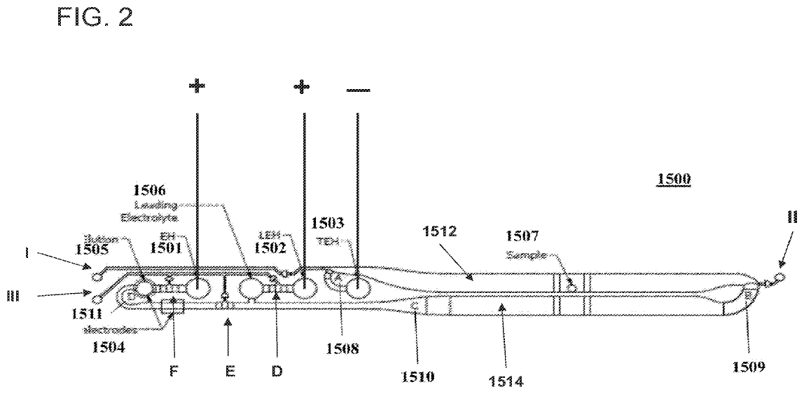

FIG. 2 shows an exemplary fluidic circuit for performing isotachophoresis (“ITP”). As shown in FIG. 2, ITP channel 1500 can comprise trailing electrolyte buffer reservoir 1503, cliff capillary barrier A, sample channel 1512 comprising sample inlet port 1507, cliff capillary barrier B, ITP channel 1514, a first branch comprising leading electrolyte buffer reservoir 1506, notch capillary barrier D, and leading electrolyte buffer reservoir 1502. A second branch can comprise notch capillary barrier E, elution buffer reservoir 1505, notch capillary barrier F and elution buffer reservoir 1501. Driving electrodes can be placed in the higher ionic strength buffered elution electrode (EH) reservoir 1501 and the higher ionic strength buffered leading electrolyte (LEH) reservoir 1502, and a ground electrode can be placed in the buffered trailing electrolyte (TEH) reservoir 1503. Also shown are pneumatic port I, which connects through a pneumatic channel to capillary barrier A; pneumatic port II, which connects through pneumatic channel to capillary barrier B; and pneumatic port III, which connects through a pneumatic channel to capillary barriers D, E, and F. Further shown is conductivity detector (e.g., capacitively-coupled contactless conductivity detector (C4D)) electrodes 1504 can be placed outside of the chip, such as near the elution reservoir 1505. Also shown is trigger point 1510 for determining proper current in the channel. Further shown are an anode (−) and two cathodes (+) positioned in reservoirs.

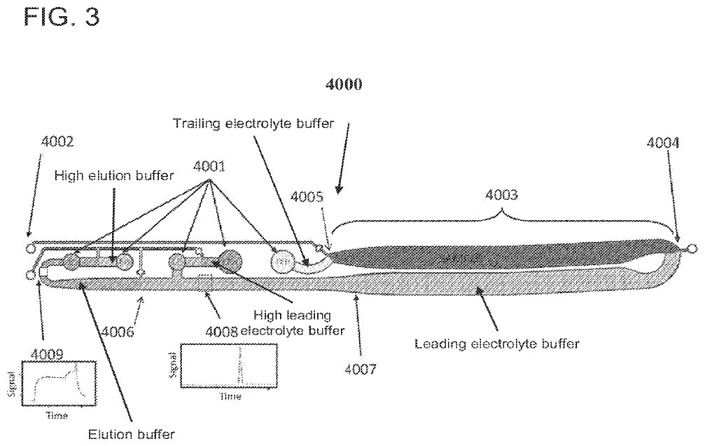

FIG. 3 shows an exemplary fluidic circuit 4000 comprising voltage and temperature sensing. The circuit can comprise fluids in liquid contact with one another. These can include, as shown in this example, sample fluid, trailing electrolyte buffer, leading electrolyte buffer, high leading electrolyte buffer (higher ionic strength), elution buffer, and high elution buffer (higher ionic strength).

The fluidic circuit 4000 may be substantially similar to the circuits described in FIG. 2. The fluidic circuit 4000 may be comprise a channel connected to a sample input well or reservoir, an elution reservoir (“EB”), a higher ionic strength elution buffering reservoir (“EBH”), a leading electrolyte reservoir (“LE”), a higher ionic strength leading electrolyte buffering reservoir (“LEH”), and a trailing electrolyte reservoir (“TEH”) as described herein. The reservoirs 4001 may be positioned in the fluidic device (e.g. device 3700) such that the wells 4001 are at standard locations for a microtiter plate as described herein. Reservoirs 4001 may be coupled to the channel by through-holes or apertures as described herein. A capillary barrier (e.g., a notch capillary barrier) may be provided in the leading electrolyte buffering channel (between LE and LEH) to reduce or prevent mixing or pressure-driven flow between the contents of the leading electrolyte buffering reservoir (LEH) and the leading electrolyte reservoir (LE) as described herein. The device 4000 may further comprise pneumatic ports 4002 along its edges which are configured to couple to a pneumatic device, for example a vacuum source on a benchtop instrument. The pneumatic ports 4002 may be positioned in the device at standard locations for interfacing with commonly-available pneumatic manifolds. The pneumatic ports 4002 may be coupled to the channels and reservoirs by pneumatic channels as described herein. Application of suction (i.e. negative pneumatic pressure) at the pneumatic ports 4002 may load the sample, leading electrolyte, and elution buffer into the channels as described herein. The pneumatic channels 4002 may be coupled to the channels at one or more capillary barriers such that the negative pressure is applied to said capillary barriers as described herein. Suction may be applied simultaneously or sequentially to the pneumatic ports 4002 so as to load the channels simultaneously or in stages, respectively. The sample may be loaded into a first zone or sub-channel 4003 which extends from the trailing electrolyte reservoir (“TEH”) to a capillary barrier 4004 at a 180° low dispersion turn in the channel. The capillary barrier 4004 may provide an interface between the sample and the leading electrolyte buffer during loading so as to limit, reduce, or prevent mixing or pressure-driven flow. The capillary barrier 4004 may comprise a cliff capillary barrier as described herein. The capillary barrier 4004 may enable bubble-free priming or loading of the sample and elution buffer within the channel 4000 as described herein. The capillary barrier 4004 may be used for feedback triggering as described herein. For example, when the ITP band passes the capillary barrier 4004, the derivative of the voltage may exhibit a peak. This peak may trigger the instrument to perform additional voltage signal processing as described herein. The trailing electrolyte reservoir (TEH) may be connected to channel first zone or sub-channel by a trailing electrolyte channel. A capillary barrier 4005 (e.g. a cliff capillary barrier) may be provided in the trailing electrolyte channel between the trailing electrolyte reservoir (TEH) and the first zone or sub-channel 4003 so as to limit, reduce, or prevent mixing or pressure-driven flow between the contents of the trailing electrolyte reservoir (TEH) and the sample as described herein. The leading electrolyte may be loaded into the second zone or sub-channel of the channel which extends from capillary barrier 4004 to a capillary barrier 4006 (e.g., a notch capillary barrier) which may provide an interface between the leading electrolyte buffer and the elution buffer. A narrowing or construction 4007 may be provided within the second zone of the channel. The construction 4007 may be used for feedback triggering as described herein. For example, when the ITP band passes the construction 4007, the derivative of the voltage may exhibit a peak. This peak may trigger the instrument to perform additional signal processing (e.g. temperature signal processing) as described herein. The first zone or sub-channel 4003 and the second zone or sub-channel may make up an ITP branch of the fluidic channel or circuit 4000. The elution buffer may be loaded into a third zone or sub-channel of channel which extends from capillary barrier 4006 to the elution reservoir (EB). The third zone or sub-channel may make up an elution branch of the fluidic channel or circuit 4000.

c. Capillary Barriers

A fluidic conduit can be considered to have an axis pointing along the direction of fluid flow. In describing the geometry of a capillary barrier positioned in a fluidic conduit one can refer to the channel in longitudinal or transverse section; a longitudinal section is a plane along or parallel to the axis of the conduit, while a transverse section is a plane substantially orthogonal to the axis. Longitudinal sections can be sagittal (along the line of symmetry (e.g., left-right sides of a channel) or frontal (e.g., top-bottom sides of a channel).

Accordingly, changes in cross-sectional area of a conduit can be seen in different longitudinal (sagittal) section as narrowing or widening of the conduit in the direction of fluid flow, while changes in cross-sectional area can be seen in transverse sections at different points along the axis as different areas between the sections.

A conduit is generally elongate in shape. Conduits in a finished product are generally closed, that is, they may be configured as open troughs or grooves in a substrate that is covered with a second substrate to close the conduits. In longitudinal section, they may be substantially straight or curved, and may contain acute bends. In transverse section, they may have closed curvilinear shapes, such as a circular, oval, or elliptical. Alternatively, they have polygonal shapes such as substantially trapezoidal (e.g., an isosceles trapezoid), triagonal, quadrangular (square or rectangle), pentagonal, hexagonal, etc. In other embodiments, they may have straight or curved elements.

Part or all of the interior surface of a conduit can be referred to as a “wall” of the conduit. Alternatively, the walls can be referred to as “side” or “sidewall”, “floor” or “ceiling” depending on the orientation of the conduit, e.g., with respect to gravity. Conduits have lumens, that is, the space or cavity inside a conduit. To the extent capillary barriers represent departures from a surface of a channel, surface from, which the barrier departs can be referred to as the “base” of the channel, and the level of the surface can be referred to as the “base” level.

As used herein, a “top” and “bottom” of a fluidic device refers to the sides of the device oriented away from gravity and toward gravity, respectively. Referring to FIG. 1, substrate 3702 has channels and capillary barriers disposed on the under-side of the substrate. The conduits are closed by application of substrate 3706. Substrate 3706 can be heat-bonded to the underside of substrate 3702.

It is noted that in certain embodiments fluidic channels, pneumatic channels, and capillary barriers are introduced onto the “underside” of a substrate having reservoirs on the “top side”. Accordingly, such features face gravity in operation. Accordingly, in certain figures herein, channels and capillary barriers are shown “upside down” compared to operating mode. For example, referring to FIG. 6C, when this device assumes the same orientation as the device in FIG. 1, the orientation is “upside down” compared with the orientation in FIG. 6C. Thus, substrate 6002 in FIG. 6C is oriented as a “floor” of the conduit, but in typical operation, such as in FIG. 1., it is oriented as a “ceiling” of the conduit.

The terms “higher” and “lower”, when referring to different relative aspects of edges or faces of an object in a fluidic channel, e.g., a capillary barrier, are made in reference to the base surface of the conduit from which the aspect is connected. For example, if a first ramp and a second ramp have the same run length and the first ramp has a greater rise than the second ramp, then, the top of first ramp is “higher” than the top of second ramp.

In describing the geometry of capillary barriers, one can make reference to the following structures: “ramps,” “plateaus,” “cliffs”, “notches” and “insets”.

The term “ramp” refers to a tapered rise or fall in a conduit that decreases or increases, respectively, the cross-sectional area of the conduit over its run. A ramp may be straight or curved. A ramp can have a rise-over-run of between 1° and 60°. As used herein, “rise-over-run” is a measure of the steepness of the ramp, which is described as either the degree or percentage of the slope. The slope percentage can be calculated using formula tan θ=Δy (rise)/Δx (run), where Δy is the height (“rise”) of the ramp, Δx is the length (“run”) of the ramp, tan 0 is the slope percentage, and slope degree is “0”. For example, a slope degree of 0 is equivalent to a slope percentage of 0 (tan 0), a slope degree of 30° is equivalent to a slope percentage of about 0.577 (tan) 30°, a slope degree of 45° is equivalent to a slope percentage of 1 (tan) 45°, and a slope degree of 60° is equivalent to a slope percentage of about 1.732 (tan) 60°.

The term “cliff” refers to a steep decline to, or rise from, across a run of a conduit. In some cases, a cliff can have a rise-over-run of between 60° and 90° (perpendicular).

The term “plateau” refers to a substantially flat or straight or flat segment, typically positioned between two ramps, two cliffs or a ramp and a cliff. A plateau can have a rise-over-run of no more than 10° degrees.

The term “notch” refers to an indentation or cavity in a surface of a channel. A notch can take any appropriate shape including rectangular, V-shaped or curvilinear. A notch can be disposed between two ramps, within a plateau, or as a group or indentation in a fluidic channel. For example, a notch can take the shape of two cliffs facing one another. The base or lowest point of a notch can be at, above or below the base level of a channel.

The term “inset” refers to a notch positioned in a base of a channel, and not disposed in a ramp.

As used herein, the term “face” refers to a surface that forms the boundary of a solid object. For example, a cliff may represent a face of a cliff capillary barrier. As used herein, the term “edge” refers to a boundary between two faces of a solid object. For example, the meeting of a cliff and a ramp, or a cliff and a plateau, represents an edge of a capillary barrier.

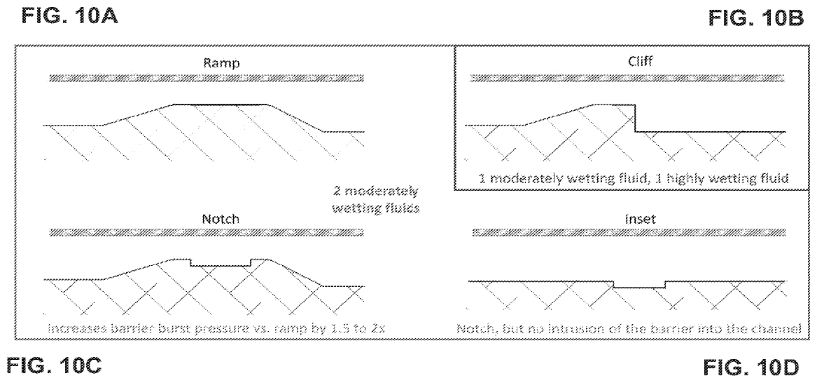

FIGS. 10A-10D show four exemplary types of capillary barrier. The “ramp”, or “plateau” barrier (FIG. 10A) can comprise two opposing ramps separated by a plateau. The “cliff” barrier (FIG. 10 B) can comprise a ramp leading to a cliff or expansion, optionally through a plateau. The “notch” barrier (FIG. 10C) can comprise two opposing ramps separated by a notch, optionally in set within a plateau. The “inset” barrier (FIG. 10 D) can comprise a notch in a base of the channel. The inset barrier does not include a narrowing of base of the channel, as the case with the other three capillary barriers.

The ability of the capillary barrier to arrest a fluid can be a function of two factors. One factor is the change in cross-sectional area of the channel created by the barrier, which changes capillary forces. A decrease in cross-sectional area can increase capillary force. Another factor is the wettability of the liquid, which can be increased by, for example, inclusion of surfactants in the liquid. The ability of a capillary barrier to arrest flow of liquid decreases with the wettability of the liquid. The plateau, notch and inset barriers can be useful for arresting liquids having similar wettability (e.g., moderately wetting fluids). A cliff barrier can be useful for arresting a moderately wetting fluid at the face of the cliff, and allowing liquid contact of a highly wetting liquid moving up the ramp side of the barrier. In some cases, notch capillary barrier comprising a notch within a plateau can have burst pressures 1.5 to 2 times as great as a plateau barrier without a notch. Greater burst pressures can allow increased ability to control movement of liquid across the barrier.

### 1. Cliff Capillary Barrier

FIGS. 4A-4B show an exemplary “cliff capillary barrier” 4110. FIG. 4A shows a top view (frontal) of a channel 4100 having a cliff capillary barrier 4110 disposed therein. FIG. 4B shows a longitudinal (sagittal) side view of the cliff capillary barrier 4110 in the channel 4100. The cliff capillary barrier 4110 may comprise a trapezoidal cross-section having a constriction within the channel 4100 formed by an angled surface 4111 and a plateau surface 4112 of the cliff capillary barrier 4110 followed by a sudden expansion within the channel formed by a cliff surface 4113. The channel 4100 may comprise a first wall 4101, a second wall 4102, a third wall 4103, and a fourth wall 4104 to form a closed channel. The channel 4100 may for example have a square or rectangular cross-section (taken along a lateral axis of the channel 4100) comprising four walls. The first and the third walls 4101, 4103 may be substantially parallel to one another. The second and the fourth walls 4102, 4104 may be substantially parallel to one another. The cliff capillary barrier 4110 may protrude from the second channel wall 4102 into the channel 4100. The cliff capillary barrier 4110 may be disposed on the second wall 4102. Alternatively, the cliff capillary barrier 4110 may form a part of the second wall 4102. The cliff capillary barrier 4110 may comprise sides that are disposed on, coextensive with, or integrated in an interior surface of the second wall 4102. The cliff capillary barrier 4110 may extend substantially the width of the channel 4100. For example, the cliff capillary barrier 4110 may extend substantially between the first and third walls 4101, 4103 as shown in FIG. 4A. The cliff capillary barrier 4110 may comprise a first and a second lateral wall or side 4114, 4115. The first and second lateral walls or sides 4114, 4115 may be connected to the first and third channel walls 4101, 4103, respectively. Alternatively, the first and second lateral walls or sides 4114, 4115 may be coextensive with the first and third channel walls 4101, 4103, respectively. Alternatively, the first and second lateral walls or sides 4114, 4115 may be adjacent to the first and third channel walls 4101, 4103, respectively. The first and second lateral walls or sides 4114, 4115 may each comprise a cross-sectional area with a trapezoidal shape (for example the cross-sectional area shown in FIG. 4B). The trapezoidal cross-section may comprise a plateau surface or side 4112 that is substantially parallel to the second channel wall 4102. The plateau surface or side 4112 may be situated in the channel 4100 between the second and fourth channel walls 4102, 4104. An angled surface or side (also referred to herein as a ramp) 4111 may connect the second wall 4102 to the plateau surface or side 4112 at a first edge 4116. A cliff surface or side 4113 may connect the second wall 4102 to the plateau surface or side 4112 at a second, opposite edge 4117.

The angled surface or side 4111 may be configured to gradually reduce the height of the channel 4100 from a first height h₁ to a second, smaller height h₂, over a distance along the length of the channel. The first height h₁ may be at least twice as large as the second height h₂. The angled surface or side 4111 may for example be an incline plane rising from a bottom wall of the channel 4100 or a decline plane lowering from a top wall of the channel 4100. The angled surface or side 4111 may for example be an angled plane extending into the channel 4100 from a side wall of the channel 4100. The angled surface or side 4111 may have a first edge 4116 which intersects with the plateau region or side 4112 to form an interior obtuse angle of the cliff capillary barrier and a second, opposing edge 4118 which intersects with the second channel wall 4102 to form an interior acute angle θ of the cliff capillary barrier 4110.

The cliff surface or side 4113 may be configured to suddenly increase the height of the channel 4100 from a first height h₂ to a second, larger height h₃, over a very short distance or no distance along the length of the channel 4100. The cliff surface or side 4113 may for example be a vertical surface (relative to the second wall 4102) connecting the plateau surface or side 4112 to the second wall 4102. The cliff surface or side 4113 may for example be substantially perpendicular to the second wall 4102.

Liquid wicking up the angled surface or side to the plateau surface or side 4111 may face an energetic barrier associated with expanding past the plateau surface or side 4112 (as additional liquid surface area or pressure is required to advance the liquid) which may result in the liquid being stopped by the cliff capillary barrier 4110 and a meniscus of the liquid being positioned at the edge 4116 of the plateau surface or side 4112 nearest the angled surface or side 4111 or the edge 4116 above the cliff surface or side 4113. The cliff capillary barrier 4110 may be configured such that the liquid stopped by the capillary barrier 4110 can be wetted by liquid approaching the cliff capillary barrier 4110 from its other side (e.g. from the cliff side 4113) to create a bubble-free liquid-to-liquid interface. The cliff capillary barrier 4110 may be disposed adjacent a pneumatic channel 4120 configured to facilitate air bubble removal from the channel 4100 as the liquid enters the channel 4100 and the meniscus of the liquid is stopped at the cliff capillary barrier 4110 as described herein.

The cliff capillary barrier 4110 may be configured to hold the menisci of the liquids on either side of the cliff capillary barrier 4110 separate, with an air gap between them spanning the plateau surface or side 4112 until a pressure applied across the capillary barrier via the air channel 4120 exceeds the burst pressure of the cliff capillary barrier 4110 and one or both of the liquids cross the plateau surface or side 4112 to meet each other and form a liquid-to-liquid interface as described herein.

The cliff capillary barrier 4110 may be configured to hold or stop a liquid when a pneumatic pressure is applied thereto. The cliff capillary barrier 4110 may be configured to hold the liquid under a pressure within a range of about 0 mpsi to about 200 mpsi, for example within a range of about 10 mpsi to about 80 mpsi. The cliff capillary barrier 4110 may be configured to hold the liquid until a burst pressure (e.g. the minimum pressure required to move the stopped liquid over plateau 4112 and/or the cliff 4113 and past the cliff capillary barrier 4110) is reached. It will be understood by one of ordinary skill in the art that the burst pressure of the cliff capillary barrier 4110 may depend on the liquid(s) being held by the cliff capillary barrier 4110, with more wetting liquids having a lower burst pressure than less wetting liquids.

The angled surface or side 4111 may be configured to gradually reduce the height of the channel 4100 from a first height h₁ within a range of about 50 μm to about 2 mm to a second height h₂ within a range of about 50 μm to about 400 μm. The first height h₁ may for example be within a range of about 400 μm to about 1.2 mm.

The angled surface or side 4111 may have a first edge 4116 which intersects with the plateau region or side 4112 to form an interior obtuse angle of the cliff capillary barrier 4110.

The angled surface or side 4111 may have a second, opposing edge 4118 which intersects with the second channel wall 4102 to form an interior acute angle θ of the cliff capillary barrier 4110. The interior acute angle θ may be within a range of about 0 degrees to about 70 degrees, for example within a range of about 30 degrees to about 45 degrees or within a range of about 30 degrees to about 60 degrees.

The plateau surface or side 4112 may have a length along a longitudinal axis of the channel 4110 within a range of about 200 μm to about 1 mm, for example about 600 μm.

The cliff surface or side 4113 may be substantially perpendicular to the second channel wall 4102 and/or the plateau surface or side 4112. The cliff surface or side 4113 may intersect the second channel wall 4102 to form an interior angle φ within a range of about 60 degrees to about 90 degrees.

The ramp 4111, plateau area 4112, or cliff area 4113, in any combination, may have a substantially flat surface.

The ramp 4111, plateau area 4112, or cliff area 4113, in any combination, may have a curved surface.

The ramp 4111, plateau area 4112, or cliff area 4113, in any combination, may have a surface that comprises one or more grooves, ridges, indentations, steps, etchings, or protrusions.

The ramp 4111, plateau area 4112, or cliff area 4113, in any combination, may have a surface that comprises regions with faces at different angles.

The depth of the channels 4100 on either side of the cliff capillary barrier 4110 may be the same. Alternatively, each side 4111, 4113 of the cliff capillary barrier 4110 may be coupled to channels 4110 of different depths. For example, the ramp portion 4111 of the cliff capillary barrier 4110 may be coupled to a sample channel 4105 comprising a depth within a range of about 10 μm to about 2 mm, for example within a range of about 400 μm to about 1.2 mm as described herein. The cliff portion 4113 of the cliff capillary barrier 4110 may be coupled to a leading electrolyte channel 4106 comprising a depth within a range of about 10 μm to about 1 mm, for example within a range of about 10 μm to about 600 μm as described herein.

So, for example, referring to FIG. 4B, when the elements are positioned adjacently as ramp-plateau-cliff 4111-4112-4113, the cliff capillary barrier 4110 can comprise a ramp 4111 rising from a surface 4102 of the channel 4100 at a shallow angle θ, a plateau area 4112 having a surface about parallel to other portions of the channel surface 4102, 4104, and a cliff 4113 falling to the surface 4102 and having an angle φ substantially steeper than the angle θ of the ramp 4111. The shallow angle θ can be less than 60 degrees, e.g., no more than 45 degrees or no more than 30 degrees. The cliff angle φ can be greater than 60 degrees, e.g., about 90 degrees. The plateau 4112 can be no more than 10 degrees off parallel to the channel surface 4102.

The cliff can create an abrupt change in the internal cross-sectional area of the channel. Typically, the cliff takes the shape of a steep wall, which can be flat or curved, and which rises at an angle from the base of the channel at an angle of about 80 degrees to about 100 degrees, e.g., about 90 degrees.

In some embodiments, the burst pressure of the cliff capillary barrier 4110 may be the same as the burst pressure of plateau capillary barrier 4210 or notch capillary barrier 6010. Typically, the burst pressure of the cliff capillary barrier 4110 is higher than the burst pressure of plateau capillary barrier 4210 or notch capillary barrier 6010. The higher burst pressure of the cliff capillary barrier 4110 may facilitate loading (and stopping) of liquids which have lower surface tensions, for example liquids comprising one or more surfactants or detergents. For example, the sample may have a low enough surface tension so as to wet across a cliff capillary barrier 4110 under the negative pneumatic pressure applied by the instrument to the channel. In such case, the sample may be bounded within the channel by cliff capillary barriers 4004 (e.g. a first cliff capillary barrier between the sample and the LE) and a second cliff capillary barrier 4005 between the sample and the TE, so as to hold the sample in the channel during loading of the chip.

### 2. Plateau Capillary Barrier

A “plateau” or “ramp” capillary barrier comprises a first tapered area, or ramp, and a cliff. Optionally, a “ramp” capillary barrier may include a plateau. The first tapered area and the plateau, if present, can have shapes and dimensions as described for the notch capillary barrier. The plateau can be present for ease of manufacturing, by avoiding sharp angles.

FIGS. 5A-5B show an exemplary “plateau capillary barrier” 4210. FIG. 5A shows a top view of a channel 4200 having a plateau capillary barrier 4210 disposed therein. FIG. 5B shows a longitudinal cross-sectional side view of the plateau capillary barrier 4210 in the channel 4200. The plateau capillary barrier 4210 may comprise a trapezoidal cross-section having a constriction within the channel 4200 formed by a first angled surface 4211 and a plateau surface 4212 of the plateau capillary barrier 4210 followed by a gradual expansion within the channel 4200 formed by a second angled surface 4213. The channel 4200 may comprise a first wall 4201, a second wall 4202, a third wall 4203, and a fourth wall 4204 to form a closed channel. The channel 4200 may for example have a square or rectangular cross-section (taken along a lateral axis of the channel 4200) comprising four walls. The first and the third walls 4201, 4203 may be substantially parallel to one another. The second and the fourth walls 4202, 4204 may be substantially parallel to one another. The plateau capillary barrier 4210 may protrude from the second channel wall 4202 into the channel 4200. The plateau capillary barrier 4210 may be disposed on the second wall 4202.

In an exemplary embodiment, channel depth, that is, h₄ or h₆, can be between about 200 μm to about 1000 μm, e.g., about 400 μm to about 500 μm. The gap (h₅) between the top of the plateau and the opposing wall can be between about 50 μm and about 500 μm, e.g., between about 75 μm to about 150 μm. Accordingly, the height of the plateau can be between about 150 μm to about 500 μm.

The ramps can take any appropriate configuration, including flat or curved planes. An edge between the plateau and the ramp may be curved or straight. The line of such edges may be perpendicular to the longitudinal axis of the channel. Alternatively, it may be oriented obliquely, as shown in FIG. 5A.

Alternatively, the plateau capillary barrier 4210 may form a part of the second wall 4202. The plateau capillary barrier 4210 may comprise sides that are disposed on, coextensive with, or integrated in an interior surface of the second wall 4202. The plateau capillary barrier 4210 may extend substantially the width of the channel 4200. For example, the plateau capillary barrier 4210 may extend substantially between the first and third walls 4101, 4013 as shown in FIG. 4A. The plateau capillary barrier 4210 may comprise a first and a second lateral wall or side 4214, 4215. The first and second lateral walls or sides 4214, 4215 may be connected to the first and third channel walls 4201, 4203, respectively.

Alternatively, the first and second lateral walls or sides 4214, 4215 may be coextensive with the first and third channel walls 4201, 4203, respectively. Alternatively, the first and second lateral walls or sides 4214, 4215 may be adjacent to the first and third channel walls 4201, 4203, respectively. The first and second lateral walls or sides 4214, 4215 may each comprise a cross-sectional area with a trapezoidal shape (for example the cross-sectional area shown in FIG. 5B). The trapezoidal cross-section may comprise a plateau surface or side 4212 that is substantially parallel to the second channel wall 4202. The plateau surface or side 4212 may be situated in the channel 4200 between the second and fourth channel walls 4202, 4204. A first angled surface or side 4211 (also referred to herein as a ramp) may connect the second wall 4202 to the plateau surface or side 4212 at a first edge. A second angled surface or side 4213 may connect the second wall 4204 to the plateau surface or side 4212 at a second, opposite edge 4217.

The first angled surface or side 4211 may be configured to gradually reduce the height of the channel 4200 from a first height h₄ to a second, smaller height h₅, over a distance along the length of the channel 4200. The first height h₄ may be at least twice as large as the second height h₅. The first angled surface or side 4211 may for example be an incline plane rising from a bottom wall of the channel 4200 or a decline plane lowering from a top wall of the channel 4200. The first angled surface or side 4211 may for example be an angled plane extending into the channel 4200 from a side wall of the channel 4200. The first angled surface or side 4211 may have a first edge 4216 which intersects with the plateau region or side 4212 to form an interior obtuse angle of the plateau capillary barrier 4210 and a second, opposing edge 4218 which intersects with the second channel wall 4202 to form an interior acute angle α of the plateau capillary barrier 4210.

The second angled surface or side 4213 may be configured to gradually increase the height of the channel 4200 from a first height h₅ to a second, larger height h₆, over a distance along the length of the channel 4200. The first height h₅ may be at least twice as small as the second height h₆. The second angled surface or side 4213 may for example be a decline plane lowering from a bottom wall of the channel 4200 or an incline plane rising from a top wall of the channel 4200. The second angled surface or side 4213 may for example be an angled plane extending towards a side wall of the channel 4200 from the plateau surface or side 4212. The second angled surface or side 4213 may have a first edge 4217 which intersects with the plateau region or side 4212 to form an interior obtuse angle of the plateau capillary barrier 4210 and a second, opposing edge 4219 which intersects with the second channel wall 4202 to form an interior acute angle β of the plateau capillary barrier 4210.

Liquid wicking up the first angled surface or side 4211 to the plateau surface or side 4212 may face an energetic barrier associated with expanding past the plateau surface or side 4212 (as additional liquid surface area or pressure is required to advance the liquid) which may result in the liquid being stopped by the plateau capillary barrier 4210 and a meniscus of the liquid being positioned at the edge 4216 of the plateau surface or side 4212 nearest the first angled surface or side 4211 or the edge 4217 above the second angled surface or side 4213. The plateau capillary barrier 4210 may be configured such that the liquid stopped by the plateau capillary barrier 4210 can be wetted by liquid approaching the plateau capillary barrier 4210 from its other side (e.g. from the second angled side) to create a bubble-free liquid-to-liquid interface. The plateau capillary barrier 4210 may be disposed adjacent a pneumatic channel 4220 configured to facilitate air bubble removal from the channel 4200 as the liquid enters the channel 4200 and the meniscus of the liquid is stopped at the plateau capillary barrier 4210 as described herein.

The plateau capillary barrier 4210 may be configured to hold the menisci of the liquids on either side of the plateau capillary barrier 4210 separate, with an air gap between them spanning the plateau surface or side 4212 until a pressure applied across the capillary barrier 4210 via the air channel 4220 exceeds the burst pressure of the plateau capillary barrier 4210 and one or both of the liquids cross the plateau surface or side 4212 to meet each other and form a liquid-to-liquid interface as described herein (e.g., as shown in FIG. 5A and FIG. 5B).

The plateau capillary barrier 4210 may be configured to hold or stop a liquid when a pneumatic pressure is applied thereto. The plateau capillary barrier 4210 may be configured to hold the liquid under a pressure within a range of about 0 mpsi to about 200 mpsi, for example within a range of about 10 mpsi to about 80 mpsi. The plateau capillary barrier 4210 may be configured to hold the liquid until a burst pressure (e.g. the minimum pressure required to move the stopped liquid over plateau 4112 and/or onto the second angled region 4213 and past the plateau capillary barrier 4210) is reached. It will be understood by one of ordinary skill in the art that the burst pressure of the plateau capillary barrier 4210 may depend on the liquid(s) being held by the plateau capillary barrier 4210, with more wetting liquids having a lower burst pressure than less wetting liquids.

The first angled surface or side 4211 may be configured to gradually reduce the height of the channel 4200 from a first height h₄ within a range of about 50 μm to about 2 mm to a second height h₅ within a range of about 10 μm to about 30 μm. The first height h₄ may, for example, be within a range of about 400 μm to about 1.2 mm.

The first angled surface or side 4211 may have a first edge 4216 which intersects with the plateau region or side 4212 to form an interior obtuse angle of the plateau capillary barrier 4210.

The first angled surface or side 4211 may have a second, opposing edge 4218 which intersects with the second channel wall 4202 to form an interior acute angle α of the plateau capillary barrier 4210. The interior acute angle α may be within a range of about 0 degrees to about 70 degrees, for example within a range of about 30 degrees to about 45 degrees or within a range of about 30 degrees to about 60 degrees.

The plateau surface or side 4212 may have a length along a longitudinal axis of the channel within a range of about 500 μm to about 1 mm, for example about 750 μm.

The second angled surface or side 4213 may be configured to gradually increase the height of the channel from a first height h₅ within a range of about 10 μm to about 30 μm to a second height h₆ within a range of about 50 μm to about 2 mm. The first height h₅ may for example be within a range of about 400 μm to about 1.2 mm.

The second angled surface or side 4213 may have a first edge 4217 which intersects with the plateau region or side 4212 to form an interior obtuse angle of the plateau capillary barrier 4210.

The second angled surface or side 4213 may have a second, opposing edge 4219 which intersects with the second channel wall 4202 to form an interior acute angle β of the plateau capillary barrier 4210. The interior acute angle β may be within a range of about 0 degrees to about 70 degrees, for example within a range of about 30 degrees to about 45 degrees or within a range of about 30 degrees to about 60 degrees.

The first angled surface 4211 (i.e. ramp), plateau area 4212, or second angled surface area 4213, in any combination, may have a substantially flat surface.

The first angled surface 4211 (i.e. ramp), plateau area 4212, or second angled surface area 4213, in any combination, may have a curved surface.

The first angled surface 4211 (i.e. ramp), plateau area 4212, or second angled surface area 4213, in any combination, may have a surface that comprises one or more grooves, ridges, indentations, steps, etchings, or protrusions.

The first angled surface 4211 (i.e. ramp), plateau area 4212, or second angled surface area 4213, in any combination, may have a surface that comprises regions with faces at different angles.

So, for example, referring to FIG. 5B, the ramp barrier can comprise two ramps separated by a plateau. A first ramp 4211 can rise from a surface of the channel 4202 at a shallow angle α, a plateau area 4212 can be about parallel to the channel 4200 and a second ramp 4213 can fall to the channel surface 4202 at a shallow angle β. The shallow angles α, β can be no more than 60 degrees, no more than 45 degrees or no more than 30 degrees. The shallow angles α, β can be the same angle or different angles.

The depth of the channels 4200 on either side of the plateau capillary barrier 4210 may be the same. Alternatively, each side of the plateau capillary barrier 4210 may be coupled to channels 4200 of different depths as described herein.

This can be accomplished as follows. The barrier comprises a ramp that very gradually increases the capillary pressure. This enables fine control of the process of bringing two liquids together. It also helps automation of this process. It has been found that abrupt changes in geometry can result in bubbles trapped in the abrupt concave spaces associated with such abrupt variation. Bubbles interfere with ITP (including dispersion of sample and catastrophic disruption), create uncertainties in fill volume, pose nucleation sites for degassing, cause Joule heating, etc. Even these concave “dead spaces” are filled with liquid, they are regions of very low electric field. Analyte, such as DNA gets trapped there. This creates dispersion and can cause effective loss of sample. In contrast, gradual changes avoid inertial effects.

### 3. Notch Capillary Barrier

FIGS. 6A-6C show an exemplary “notch capillary barrier” 6010. A notch capillary barrier can have a configuration substantially the same as a plateau barrier, except that a notch is included in the plateau, or the plateau is absent and the notch is positioned between two ramps.

FIG. 6A shows a top view of a channel 6000 having a notch capillary barrier 6010 disposed therein. FIG. 6B shows an isometric view of the notch capillary barrier. FIG. 6C shows a longitudinal (sagittal) cross-sectional side view of the notch capillary barrier 6010 in the channel 6000. The notch capillary barrier 6010 may comprise a trapezoidal cross-section comprising a notch and having a constriction within the channel 6000 formed by a first angled surface 6011 and a notch 6012 of the notch capillary barrier 6010 followed by a gradual expansion within the channel 6000 formed by a second angled surface 6013. Also seen are cliff faces 6030 and 6031. The channel 6000 may comprise a first wall 6001, a second wall 6002, a third wall 6003, and a fourth wall 6004 to form a closed channel. The channel 6000 may for example have a square or rectangular cross-section (taken along a lateral axis of the channel 6000) comprising four walls. The first and the third walls 6001, 6003 may be substantially parallel to one another. The second and the fourth walls 6002, 6004 may be substantially parallel to one another. The notch capillary barrier 6010 may protrude from the second channel wall 6002 into the channel 6000. The notch capillary barrier 6010 may be disposed on the second wall 6002.

In an exemplary embodiment, channel depth, that is, h₄ or h₆, can be between about 200 μm to about 1000 μm, e.g., about 400 μm to about 500 μm. The gap (h₅) between the top of the plateau and the opposing wall can be between about 50 μm and 500 μm, e.g., between about 75 μm to about 150 μm. Accordingly, the height of the plateau can be between about 150 μm to about 500 μm. The depth of the notch in a notch capillary barrier or inset barrier can be between about 10 μm to about 200 μm, e.g., about 50 μm.

The ramps can take any appropriate configuration, including flat or curved planes. Edge between the notch, an optional plateau and the ramp may be curved or straight. For example, the edge of the notch can take a convex shape relative to the axis of the ramp to which it is attached and, accordingly, in the shape of the meniscus of the liquid moving up the ramp. The line of such edges may be perpendicular to the longitudinal axis of the channel. Alternatively, it may be oriented obliquely, as shown in FIG. 6A. The notch may be disposed in a plateau region. Alternatively, the notch can be disposed directly between tops of the ramps, for example as shown in FIG. 9.

Alternatively, the notch capillary barrier 6010 may form a part of the second wall 6002. The notch capillary barrier 6010 may comprise sides that are disposed on, coextensive with, or integrated in an interior surface of the second wall 6002. The notch capillary barrier 6010 may extend substantially the width of the channel 6000. For example, the notch capillary barrier 6010 may extend substantially between the first and third walls 4101, 4013 as shown in FIG. 4A. The notch capillary barrier 6010 may comprise a first and a second lateral wall or side 6014, 6015. The first and second lateral walls or sides 6014, 6015 (not shown) may be connected to the first and third channel walls 6001, 6003, respectively. Alternatively, the first and second lateral walls or sides 6014, 6015 may be coextensive with the first and third channel walls 6001, 6003, respectively.

Alternatively, the first and second lateral walls or sides 6014, 6015 may be adjacent to the first and third channel walls 6001, 6003, respectively. The first and second lateral walls or sides 6014, 6015 may each comprise a cross-sectional area with a trapezoidal shape (for example the cross-sectional area shown in FIG. 6B). The trapezoidal cross-section may comprise a plateau surface or side 6012 that is substantially parallel to the second channel wall 6002. The plateau surface or side 6012 may be situated in the channel 6000 between the second and fourth channel walls 6002, 6004. A first angled surface or side 6011 (also referred to herein as a “ramp”) may connect the second wall 6002 to the plateau surface or side 6012 at a first edge. A second angled surface or side 6013 may connect the second wall 6004 to the plateau surface or side 6012 at a second, opposite edge 6017.

The first angled surface or side 6011 may be configured to gradually reduce the height of the channel 6000 from a first height h₄ to a second, smaller height h₅, over a distance along the length of the channel 6000. The first height h₄ may be at least twice as large as the second height h₅. The first angled surface or side 6011 may for example be an incline plane rising from a bottom wall of the channel 6000 or a decline plane lowering from a top wall of the channel 6000. The first angled surface or side 6011 may for example be an angled plane extending into the channel 6000 from a side wall of the channel 6000. The first angled surface or side 6011 may have a first edge 6016 which intersects with the plateau region or side 6012 to form an interior obtuse angle of the notch capillary barrier 6010 and a second, opposing edge 6018 which intersects with the second channel wall 6002 to form an interior acute angle α of the notch capillary barrier 6010.

The second angled surface or side 6013 may be configured to gradually increase the height of the channel 6000 from a first height h₅ to a second, larger height h₆, over a distance along the length of the channel 6000. The first height h₅ may be at least twice as small as the second height h₆. The second angled surface or side 6013 may for example be a decline plane lowering from a bottom wall of the channel 6000 or an incline plane rising from a top wall of the channel 6000. The second angled surface or side 6013 may for example be an angled plane extending towards a side wall of the channel 6000 from the plateau surface or side 6012. The second angled surface or side 6013 may have a first edge 6017 which intersects with the plateau region or side 6012 to form an interior obtuse angle of the notch capillary barrier 6010 and a second, opposing edge 6019 which intersects with the second channel wall 6002 to form an interior acute angle β of the notch capillary barrier 6010.

Liquid wicking up the first angled surface or side 6011 to the plateau surface or side 6012 may face an energetic barrier associated with expanding past the plateau surface or side 6012 (as additional liquid surface area or pressure is required to advance the liquid) which may result in the liquid being stopped by the notch capillary barrier 6010 and a meniscus of the liquid being positioned at the notch edge 6016 of the plateau surface or side 6012 nearest the first angled surface or side 6011 or the notch edge 6017 above the second angled surface or side 6013. The notch capillary barrier 6010 may be configured such that the liquid stopped by the notch capillary barrier 6010 can be wetted by liquid approaching the notch capillary barrier 6010 from its other side (e.g. from the second angled side) to create a bubble-free liquid-to-liquid interface. The notch capillary barrier 6010 may be disposed adjacent a pneumatic channel 6020 configured to facilitate air bubble removal from the channel 6000 as the liquid enters the channel 6000 and the meniscus of the liquid is stopped at the notch capillary barrier 6010 as described herein.

The notch capillary barrier 6010 may be configured to hold the menisci of the liquids on either side of the notch capillary barrier 6010 separate, with an air gap between them spanning the plateau surface or side 6012 until a pressure applied across the capillary barrier 6010 via the air channel 6020 exceeds the burst pressure of the notch capillary barrier 6010 and one or both of the liquids cross the plateau surface or side 6012 to meet each other and form a liquid-to-liquid interface as described herein. Also shown is port 6035.

The notch capillary barrier 6010 may be configured to hold or stop a liquid when a pneumatic pressure is applied thereto. The notch capillary barrier 6010 may be configured to hold the liquid under a pressure within a range of about 0 mpsi to about 400 mpsi, for example within a range of about 10 mpsi to about 160 mpsi. The notch capillary barrier 6010 may be configured to hold the liquid until a burst pressure (e.g. the minimum pressure required to move the stopped liquid over plateau 6012 and/or onto the second angled region 6013 and past the notch capillary barrier 6010) is reached. It will be understood by one of ordinary skill in the art that the burst pressure of the notch capillary barrier 6010 may depend on the liquid(s) being held by the notch capillary barrier 6010, with more wetting liquids having a lower burst pressure than less wetting liquids.

The first angled surface or side 6011 may be configured to gradually reduce the height of the channel 6000 from a first height h₄ within a range of about 50 μm to about 2 mm to a second height h₅ within a range of about 10 μm to about 30 μm. The first height h₄ may for example be within a range of about 400 μm to about 1.2 mm.

The first angled surface or side 6011 may have a first edge 6016 which intersects with the plateau region or side 6012 to form an interior obtuse angle of the notch capillary barrier 6010.

The first angled surface or side 6011 may have a second, opposing edge 6018 which intersects with the second channel wall 6002 to form an interior acute angle α of the notch capillary barrier 6010. The interior acute angle α may be within a range of about 0 degrees to about 70 degrees, for example within a range of about 30 degrees to about 45 degrees or within a range of about 30 degrees to about 60 degrees.

The plateau surface or side 6012 may have a length along a longitudinal axis of the channel within a range of about 500 μm to about 1 mm, for example about 750 μm.

The second angled surface or side 6013 may be configured to gradually increase the height of the channel from a first height h₅ within a range of about 10 μm to about 30 μm to a second height h₆ within a range of about 50 μm to about 2 mm. The first height h₅ may for example be within a range of about 400 μm to about 1.2 mm.

The second angled surface or side 6013 may have a first edge 6017 which intersects with the plateau region or side 6012 to form an interior obtuse angle of the notch capillary barrier 6010.

The second angled surface or side 6013 may have a second, opposing edge 6019 which intersects with the second channel wall 6002 to form an interior acute angle β of the notch capillary barrier 6010. The interior acute angle β may be within a range of about 0 degrees to about 70 degrees, for example within a range of about 30 degrees to about 45 degrees or within a range of about 30 degrees to about 60 degrees.

The first angled surface 6011 (i.e. ramp), plateau area 6012, or second angled surface area 6013, in any combination, may have a substantially flat surface.

The first angled surface 6011 (i.e. ramp), plateau area 6012, or second angled surface area 6013, in any combination, may have a curved surface.

The first angled surface 6011 (i.e. ramp), plateau area 6012, or second angled surface area 6013, in any combination, may have a surface that comprises one or more grooves, ridges, indentations, steps, etchings, or protrusions.

The first angled surface 6011 (i.e. ramp), plateau area 6012, or second angled surface area 6013, in any combination, may have a surface that comprises regions with faces at different angles.

So, for example, referring to FIG. 6B, the ramp barrier can comprise two ramps separated by a plateau. A first ramp 6011 can rise from a surface of the channel 6002 at a shallow angle α, a plateau area 6012 can be about parallel to the channel 6000 and a second ramp 6013 can fall to the channel surface 6002 at a shallow angle β. The shallow angles α, β can be no more than 75 degrees, no more than 60 degrees, no more than 45 degrees, no more than 30 degrees, or no more than 15 degrees. The shallow angles α, β can be the same angle or different angles. In some cases, the shallow angles α, β can be at least 15 degrees, at least 30 degrees, at least 45 degrees, at least 60 degrees, or at least 75 degrees.

The depth of the channels 6000 on either side of the notch capillary barrier 6010 may be the same. Alternatively, each side of the notch capillary barrier 6010 may be coupled to channels 6000 of different depths as described herein.

In some embodiments, the depth of the notch can be 10 μm and 300 μm, e.g., between about 25 μm and about 100 μm, between 10 μm and 50 μm, between 50 μm and 100 μm, between 50 μm and 150 μm, between 50 μm and 200 μm, between 50 μm and 250 μm, between 50 μm and 300 μm, between 100 μm and 150 μm, between 100 μm and 200 μm, between 100 μm and 250 μm, between 100 μm and 300 μm, between 150 μm and 200 μm, between 150 μm and 250 μm, between 150 μm and 300 μm, between 200 μm and 250 μm, between 200 μm and 300 μm, or between 250 μm and 300 μm. In some case, the depth of the notch can be at least 10 μm, at least 20 μm, at least 30 μm, at least 40 μm, at least 50 μm, at least 60 μm, at least 70 μm, at least 80 μm, at least 90 μm, at least 100 μm, at least 125 μm, at least 150 μm, at least 175 μm, at least 200 μm, at least 225 μm, at least 250 μm, at least 275 μm, or at least 300 μm. In some cases, the depth of the notch can be at most 20 μm, at most 30 μm, at most 40 μm, at most 50 μm, at most 60 μm, 60 μm, at most 70 μm, at most 80 μm, at most 90 μm, at most 100 μm, at most 125 μm, at most 150 μm, at most 175 μm, at most 200 μm, at most 225 μm, at most 250 μm, at most 275 μm, or at most 300 μm.

As used herein, the “height” of the notch barrier refers to the distance (or gap) between the top of the ramp and the opposing wall (shown as “h₅” in FIG. 6C). In some cases, the disclosed notch capillary barrier has a gap (h₅) between the top of the plateau and the opposing wall of at least 50 μm, at least 60 μm, at least 70 μm, at least 80 μm, at least 90 μm, at least 100 μm, at least 125 μm, at least 150 μm, at least 175 μm, at least 200 μm, at least 225 μm, at least 250 μm, at least 275 μm, at least 300 μm, at least 325 μm, at least 350 μm, or at least 375 μm. In some cases, the disclosed notch capillary barrier has a gap (h₅) between the top of the plateau and the opposing wall of at most 60 μm, at most 70 μm, at most 80 μm, at most 90 μm, at most 100 μm, at most 125 μm, at most 150 μm, at most 175 μm, at most 200 μm, at most 225 μm, at most 250 μm, at most 275 μm, at most 300 μm, at most 325 μm, at most 350 μm, at most 375 μm, or at most 400 μm. In some cases, the disclosed notch capillary barrier has a gap (h₅) between the top of the plateau and the opposing wall from about 50 μm to about 400 μm. In some cases, the disclosed notch capillary barrier has a gap (h₅) between the top of the plateau and the opposing wall from about 100 μm to about 150 μm. In some cases, the disclosed notch capillary barrier has a gap (h₅) between the top of the plateau and the opposing wall from about 50 μm to about 150 μm. In some cases, the disclosed notch capillary barrier has a gap (h₅) between the top of the plateau and the opposing wall from about 50 μm to about 200 μm. In some cases, the disclosed notch capillary barrier has a gap (h₅) between the top of the plateau and the opposing wall from about 50 μm to about 250 μm. In some cases, the disclosed notch capillary barrier has a gap (h₅) between the top of the plateau and the opposing wall from about 50 μm to about 300 μm. In some cases, the disclosed notch capillary barrier has a gap (h₅) between the top of the plateau and the opposing wall from about 100 μm to about 400 μm. In some cases, the disclosed notch capillary barrier has a gap (h₅) between the top of the plateau and the opposing wall from about 100 μm to about 200 μm. In some cases, the disclosed notch capillary barrier has a gap (h₅) between the top of the plateau and the opposing wall from about 100 μm to about 300 μm. In some cases, the disclosed notch capillary barrier has a gap (h₅) between the top of the plateau and the opposing wall from about 110 μm to about 140 μm.

In some cases, the barrier height (h₅) is about 0.1 mm, about 0.11 mm, about 0.12 mm, about 0.13 mm, about 0.14 mm, about 0.15 mm, about 0.16 mm, about 0.17 mm, about 0.18 mm, about 0.19 mm, or about 0.2 mm. In some cases, the first ramp and/or the second ramp have a rise-over-run between 0.4 and 0.9. In some cases, the first ramp and/or the second ramp have a rise-over-run between about 0.5 and about 1. In some cases, the first ramp and/or the second ramp have a rise-over-run between about 1 and about 1.732. In some cases, the “rise” of the first ramp and/or the second ramp is about 0.5 mm, about 0.6 mm, about 0.7 mm, about 0.8 mm, about 0.9 mm, about 1 mm, about 1.1 mm, about 1.2 mm, about 1.3 mm, about 1.4 mm, or about 1.5 mm. In some cases, the “rise” of the first ramp and/or the second ramp is between 0.4 mm to 1.2 mm. In some cases, the “rise” of the first ramp and/or the second ramp is between 0.5 mm to 1 mm. In some cases, the “rise” of the first ramp and/or the second ramp is between 0.6 mm to 1.2 mm. In some cases, the “rise” of the first ramp and/or the second ramp is at least 0.5 mm, at least 0.6 mm, at least 0.7 mm, at least 0.8 mm, at least 0.9 mm, or at least 1 mm. In some cases, the “rise” of the first ramp and/or the second ramp is at most 0.5 mm, at most 0.6 mm, at most 0.7 mm, at most 0.8 mm, at most 0.9 mm, at most 1 mm, at most 1.1 mm, or at most 1.2 mm.

In some cases, the “run” of the first ramp and/or the second ramp is about 0.5 mm, about 0.6 mm, about 0.7 mm, about 0.8 mm, about 0.9 mm, about 1 mm, about 1.1 mm, about 1.2 mm, about 1.3 mm, about 1.4 mm, or about 1.5 mm. In some cases, the “run” of the first ramp and/or the second ramp is between 0.4 mm to 1.2 mm. In some cases, the “run” of the first ramp and/or the second ramp is between 0.5 mm to 1 mm. In some cases, the “run” of the first ramp and/or the second ramp is between 0.6 mm to 1.2 mm. In some cases, the “run” of the first ramp and/or the second ramp is at least 0.5 mm, at least 0.6 mm, at least 0.7 mm, at least 0.8 mm, at least 0.9 mm, or at least 1 mm. In some cases, the “run” of the first ramp and/or the second ramp is at most 0.5 mm, at most 0.6 mm, at most 0.7 mm, at most 0.8 mm, at most 0.9 mm, at most 1 mm, at most 1.1 mm, or at most 1.2 mm.

The dimensions of the width, length, and depth of the notch may be different in some cases. In some cases, the width is greater than the length. In some cases, the width of the notch can be at least 10%, at least 20%, at least 25%, at least 30%, at least 40%, at least 50%, at least 60%, at least 70%, at least 80%, at least 90%, or at least about 100% of the width of the capillary channel. In some cases, the width of the notch can be at most 10%, at most 20%, at most 25%, at most 30%, at most 40%, at most 50%, at most 60%, at most 70%, at most 80%, or at most 90% of the width of the capillary channel. In some embodiments, the width of the notch is between 25% and 75% of the width of the capillary channel. In some embodiments, the width of the notch is between 50% and 75% of the width of the capillary channel. In some embodiments, the width of the notch is between 25% and 75% of the width of the capillary channel.

Generally, a channel on a fluidic device has a width, height, or diameter within a range of about 0.1 mm to about 2.2 mm. The cross-sectional shape of a channel on a fluidic device can be any shape, for example, a square, triangle, rectangle, square, oval, or an irregular shape. In some cases, a channel on a fluidic device has a width, height, or diameter of less than or equal to 20 millimeters (mm), 19 mm, 18 mm, 17 mm, 16 mm, 15 mm, 14 mm, 13 mm, 12 mm, 11 mm, 10 mm, 9 mm, 8 mm 7 mm, 6 mm, 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, or 0.1 mm. In some cases, a channel on a fluidic device has a width, height, or diameter of at least 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm. In some cases, a channel on a fluidic device has a width within a range of about 1 mm to about 3.8 mm.

In some cases, leading electrolyte buffer channels, sample channels, trailing electrolyte (TE) buffer channels, or elution buffer channels, on the fluidic device can have a height within a range of about 10 μm to about 1 mm, for example less than about 600 μm. In some cases, one or more leading electrolyte buffer channels on the fluidic device can have a height within a range bounded from 2 μm to 2.2 mm.

In some cases, a channel on a fluidic device has a length of at least about 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 35 mm, 40 mm, 45 mm, 50 mm, 60 mm, 70 mm, 80 mm, 90 mm, 100 mm, 110 mm, 120 mm, 130 mm, 140 mm, 150 mm, 160 mm, 170 mm, 180 mm, 190 mm, 200 mm, 210 mm, 220 mm, 230 mm, 240 mm, 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, 410 mm, 420 mm, 430 mm, 440 mm, 450 mm, 460 mm, 470 mm, 480 mm, 490 mm, or 500 mm. In some cases, a channel on a fluidic device has a length of less than or equal to about 500 mm, 490 mm, 480 mm, 470 mm, 460 mm, 450 mm, 440 mm, 430 mm, 420 mm, 410 mm, 400 mm, 390 mm, 380 mm, 370 mm, 360 mm, 350 mm, 340 mm, 330 mm, 320 mm, 310 mm, 300 mm, 290 mm, 280 mm, 270 mm, 260 mm, 250 mm, 240 mm, 230 mm, 220 mm, 210 mm, 200 mm, 190 mm, 180 mm, 170 mm, 160 mm, 150 mm, 140 mm, 130 mm, 120 mm, 110 mm, 100 mm, 90 mm, 80 mm, 70 mm, 60 mm, 50 mm, 45 mm, 40 mm, 35 mm, 30 mm, 25 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm.

Channels on a fluidic device can have a large enough width, height, or diameter so as to accommodate a large sample volume. In some cases, a channel on a fluidic device has a width greater than its height so as to reduce a temperature rise due to Joule heating in the channel. In some cases, a channel on a fluidic device has a ratio of width to height of at least 2:1, 5:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, or 100:1. In some cases, a channel on a fluidic device has a ratio of width to height of at most 2:1, 5:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, or 100:1. In some cases, a channel on a fluidic device has a cross-sectional area less than about 0.1 mm², 0.2 mm², 0.3 mm², 0.4 mm², 0.5 mm², 0.6 mm², 0.7 mm², 0.8 mm², 0.9 mm², 1 mm², 1.1 mm², 1.2 mm², 1.3 mm², 1.4 mm², 1.5 mm², 1.6 mm², 1.7 mm², 1.8 mm², 1.9 mm², 2 mm², 2.1 mm², 2.2 mm², 2.3 mm², 2.4 mm², 2.5 mm², 2.6 mm², 2.7 mm², 2.8 mm², 2.9 mm², 3 mm², 3.1 mm², 3.2 mm², 3.3 mm², 3.4 mm², 3.5 mm², 3.6 mm², 3.7 mm², 3.8 mm², 3.9 mm², 4 mm², 4.1 mm², 4.2 mm², 4.3 mm², 4.4 mm², 4.5 mm², 4.6 mm², 4.7 mm², 4.8 mm², 4.9 mm², 5 mm², 6 mm², 7 mm², 8 mm², 9 mm², 10 mm², 11 mm², 12 mm², 13 mm², 14 mm², or 15 mm². In some cases, a channel on a fluidic device has a cross-sectional area more than about 0.1 mm², 0.2 mm², 0.3 mm², 0.4 mm², 0.5 mm², 0.6 mm², 0.7 mm², 0.8 mm², 0.9 mm², 1 mm², 1.1 mm², 1.2 mm², 1.3 mm², 1.4 mm², 1.5 mm², 1.6 mm², 1.7 mm², 1.8 mm², 1.9 mm², 2 mm², 2.1 mm², 2.2 mm², 2.3 mm², 2.4 mm², 2.5 mm², 2.6 mm², 2.7 mm², 2.8 mm², 2.9 mm², 3 mm², 3.1 mm², 3.2 mm², 3.3 mm², 3.4 mm², 3.5 mm², 3.6 mm², 3.7 mm², 3.8 mm², 3.9 mm², 4 mm², 4.1 mm², 4.2 mm², 4.3 mm², 4.4 mm², 4.5 mm², 4.6 mm², 4.7 mm², 4.8 mm², 4.9 mm², 5 mm², 6 mm², 7 mm², 8 mm², 9 mm², 10 mm², 11 mm², 12 mm², 13 mm², 14 mm², or 15 mm². In some cases, a channel on a fluidic device has a minimum length scale for heat dissipation less than about 1 micrometer (μm), 5 μm, 10 μm, 20 μm, 30 μm, 40 μm, 50 μm, 100 μm, 150 μm, 200 μm, 250 μm, 300 μm, 350 μm, 400 μm, 450 μm, 500 μm, 550 μm, or 600 μm. In some cases, a channel on a fluidic device has a minimum length scale for heat dissipation more than about 1 micrometer (μm), 5 μm, 10 μm, 20 μm, 30 μm, 40 μm, 50 μm, 100 μm, 150 μm, 200 μm, 250 μm, 300 μm, 350 μm, 400 μm, 450 μm, 500 μm, 550 μm, or 600 μm.

In some cases, a channel on a fluid device has a total volume of at least about 1 microliter to about 100 mL. In some cases, a channel on a fluid device has a total volume of about 10 μL to about 1 mL. In some cases, individual channels on the fluid device have a total volume of about 10 μL to about 1 mL.

In some cases, a fluidic device comprises more than one channel. The channels may be spaced within the fluidic device at a given density. In some cases, the edge to edge distance between channels is at least about 0.2 mm, 0.3 mm, 0.4 mm, 0.5 mm, 0.6 mm, 0.7 mm, 0.8 mm, 0.9 mm, 1 mm, 1.25 mm, 1.5 mm, 1.75 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, or 10 mm. In some cases, the edge to edge distance between channels is at most about 0.2 mm, 0.3 mm, 0.4 mm, 0.5 mm, 0.6 mm, 0.7 mm, 0.8 mm, 0.9 mm, 1 mm, 1.25 mm, 1.5 mm, 1.75 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, or 10 mm. The density of channels may be defined as a ratio of the width of the channels to the space (or distance) between channels. In some cases, the ratio of channel width to distance between channels is at least about 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1, 11:1, 12:1, 13:1, 14:1, 15:1, 16:1, 17:1, 18:1, 19:1, or 20:1.

In some cases, the total volume of all channels within a microfluidic device (e.g., chip) is 1 microliter (μL), 10 μL, 20 μL, 30 μL, 40 μL, 50 μL, 60 μL, 70 μL, 80 μL, 90 μL, 100 μL, 150 μL, 175 μL, 200 μL, 225 μL, 250 μL, 275 μL, 300 μL, 350 μL, 400 μL, 450 μL, 500 μL, 600 μL, 700 μL, 800 μL, 900 μL, 1 milliliter (mL), 2 mL, 3 mL, 4 mL, 5 mL, 6 mL, 7 mL, 8 mL, 9 mL, 10 mL, 11 mL, 12 mL, 13 mL, 14 mL, 15 mL, 16 mL, 17 mL, 18 mL, 19 mL, 20 mL, 25 mL, 30 mL, 35 mL, 40 mL, 50 mL, 55 mL, 60 mL, 65 mL, 70 mL, 75 mL, 80 mL, 85 mL, 90 mL, 95 mL, or 100 mL. In some cases, the total volume of all channels within a microfluidic device (e.g., chip) is at most about 1 microliter (μL), 10 μL, 20 μL, 30 μL, 40 μL, 50 μL, 60 μL, 70 μL, 80 μL, 90 μL, 100 μL, 150 μL, 175 μL, 200 μL, 225 μL, 250 μL, 275 μL, 300 μL, 350 μL, 400 μL, 450 μL, 500 μL, 600 μL, 700 μL, 800 μL, 900 μL, 1 milliliter (mL), 2 mL, 3 mL, 4 mL, 5 mL, 6 mL, 7 mL, 8 mL, 9 mL, 10 mL, 11 mL, 12 mL, 13 mL, 14 mL, 15 mL, 16 mL, 17 mL, 18 mL, 19 mL, 20 mL, 25 mL, 30 mL, 35 mL, 40 mL, 50 mL, 55 mL, 60 mL, 65 mL, 70 mL, 75 mL, 80 mL, 85 mL, 90 mL, 95 mL, or 100 mL.

In some cases, the fluidic circuit comprises more than one capillary barrier. For example, the fluidic circuit comprises more than one notch capillary barrier, more than one plateau capillary barrier, more than one ramp capillary barrier, and/or more than one inset capillary barrier. In some cases, the fluidic circuit comprises notch capillary barrier, plateau capillary barrier, ramp capillary barrier, or inset capillary barrier in any number or combination. In some cases, the capillary barriers have different burst pressures. For example, the fluidic circuit may comprise two notch capillary barriers, with two different burst pressures. In some examples, the fluidic circuit may comprise at least two different notch capillary barriers, with at least two different burst pressures. For example, the fluidic circuit may comprise two plateau capillary barriers, with two different burst pressures. In some examples, the fluidic circuit may comprise at least two different plateau capillary barriers, with at least two different burst pressures. For example, the fluidic circuit may comprise two inset capillary barriers, with two different burst pressures. In some examples, the fluidic circuit may comprise at least two different inset capillary barriers, with at least two different burst pressures. For example, the fluidic circuit may comprise two ramp capillary barriers, with two different burst pressures. In some examples, the fluidic circuit may comprise at least two different ramp capillary barriers, with at least two different burst pressures.

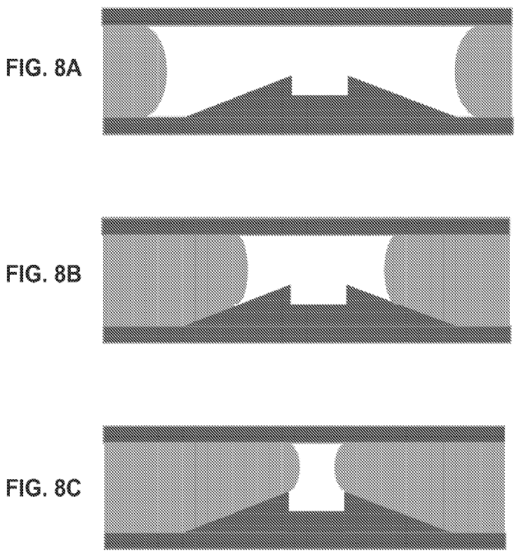

FIGS. 8A-8C show wicking of liquid up the ramps on two sides of a notch capillary barrier, and the pinning of menisci at the edges of the notch, such that the liquids do not contact one another.

### 4. Inset Capillary Barrier

FIGS. 9A and 9B show an exemplary inset barrier 9010. Longitudinal (sagittal) view 9B shows channel 9000, separated into left section 9000A, having height h₇ and right section 9000B, having height h₉, and separated by notch 9012 having height h₈. The notch is inset into the channel base, between a first base section and a second base section that are on either side of the notch. Notch 9012 comprises faces 9016 and 9017. The height of the channel on either side of the notch can be the same or different. The notch face that changes the height of the attached channel more dramatically will have a greater burst pressure.

FIG. 9B shows a top or frontal section of inset barrier 9010. In this example, cliffs 9016 and 9017 of notch 9012 how convex shape in relation to the channel side on which they are disposed. This shape mimics the shape of a meniscus of a liquid moving in the channel. This figure also shows pneumatic channel 9020 and pneumatic port 9035 opening into the space between the cliff faces. Application of sufficient negative pressure through the pneumatic channel 9020 will exceed the burst pressure of the two sides of the cliff of the inset barrier, bringing foods on either side into liquid contact. The downhole at 9016 has a very strong (35 mpsi) and consistent burst pressure, likely due to the entire contact line holding the meniscus. The inset barrier can further comprise a widening or expansion of the channel in the x-y plane (where the z axis is the direction of flow in the channel). The expansion can widen the channel by about 1% to about 30%. Such a widening help to arrest or pin a meniscus at the edge of the cliff face.

The inset barrier can, otherwise, have dimensions and attributes such as those in a notch capillary barrier. The depth of the notch in the inset barrier can be, for example, between about 10 μm to about 200 μm, e.g., about 50 μm. The depth of the notch can be 10 μm and 300 μm, e.g., between about 25 μm and about 100 μm, between 10 μm and 50 μm, between 50 μm and 100 μm, between 50 μm and 150 μm, between 50 μm and 200 μm, between 50 μm and 250 μm, between 50 μm and 300 μm, between 100 μm and 150 μm, between 100 μm and 200 μm, between 100 μm and 250 μm, between 100 μm and 300 μm, between 150 μm and 200 μm, between 150 μm and 250 μm, between 150 μm and 300 μm, between 200 μm and 250 μm, between 200 μm and 300 μm, or between 250 μm and 300 μm. In some case, the depth of the notch can be at least 10 μm, at least 20 μm, at least 30 μm, at least 40 μm, at least 50 μm, at least 60 μm, at least 70 μm, at least 80 μm, at least 90 μm, at least 100 μm, at least 125 μm, at least 150 μm, at least 175 μm, at least 200 μm, at least 225 μm, at least 250 μm, at least 275 μm, or at least 300 μm. In some cases, the depth of the notch can be at most 20 μm, at most 30 μm, at most 40 μm, at most 50 μm, at most 60 μm, 60 μm, at most 70 μm, at most 80 μm, at most 90 μm, at most 100 μm, at most 125 μm, at most 150 μm, at most 175 μm, at most 200 μm, at most 225 μm, at most 250 μm, at most 275 μm, or at most 300 μm.

In some cases, the disclosed inset capillary barrier has a gap (h₅) between the top of the plateau and the opposing wall of at least 50 μm, at least 60 μm, at least 70 μm, at least 80 μm, at least 90 μm, at least 100 μm, at least 125 μm, at least 150 μm, at least 175 μm, at least 200 μm, at least 225 μm, at least 250 μm, at least 275 μm, at least 300 μm, at least 325 μm, at least 350 μm, or at least 375 μm. In some cases, the disclosed inset capillary barrier has a gap (h₅) between the top of the plateau and the opposing wall of at most 60 μm, at most 70 μm, at most 80 μm, at most 90 μm, at most 100 μm, at most 125 μm, at most 150 μm, at most 175 μm, at most 200 μm, at most 225 μm, at most 250 μm, at most 275 μm, at most 300 μm, at most 325 μm, at most 350 μm, at most 375 μm, or at most 400 μm. In some cases, the disclosed inset capillary barrier has a gap (h₅) between the top of the plateau and the opposing wall from about 50 μm to about 400 μm. In some cases, the disclosed inset capillary barrier has a gap (h₅) between the top of the plateau and the opposing wall from about 100 μm to about 150 μm. In some cases, the disclosed inset capillary barrier has a gap (h₅) between the top of the plateau and the opposing wall from about 50 μm to about 150 μm. In some cases, the disclosed inset capillary barrier has a gap (h₅) between the top of the plateau and the opposing wall from about 50 μm to about 200 μm. In some cases, the disclosed inset capillary barrier has a gap (h₅) between the top of the plateau and the opposing wall from about 50 μm to about 250 μm. In some cases, the disclosed inset capillary barrier has a gap (h₅) between the top of the plateau and the opposing wall from about 50 μm to about 300 μm. In some cases, the disclosed inset capillary barrier has a gap (h₅) between the top of the plateau and the opposing wall from about 100 μm to about 400 μm. In some cases, the disclosed inset capillary barrier has a gap (h₅) between the top of the plateau and the opposing wall from about 100 μm to about 200 μm. In some cases, the disclosed inset capillary barrier has a gap (h₅) between the top of the plateau and the opposing wall from about 100 μm to about 300 μm. In some cases, the disclosed inset capillary barrier has a gap (h₅) between the top of the plateau and the opposing wall from about 110 μm to about 140 μm.

### II. Systems

Also provided herein are articles and systems for performing isotachophoresis. Systems can comprise an instrument and a fluidic device engaged with the instrument.

An instrument can comprise the following elements. The instrument can comprise a cartridge interface configured to engage a fluidic device as described herein. The interface can comprise guides to position the device in the proper orientation. The interface also can comprise electrodes positioned to insert into selected buffer reservoirs when the device is engaged. Referring to FIG. 2, the instrument could include electrodes for any of reservoirs 1501, 1502 or 1503. The interface could further comprise pneumatic ports positioned to mate with pneumatic ports in the fluidic device. For example, the pneumatic ports in the interface could be positioned to engage with pneumatic ports I, II and III of the device of FIG. 2. The instrument interface can comprise a base on which the fluidic device is placed and a closable lid that includes the electrodes and/or pneumatic ports. Note that reservoirs are preferred for placement of electrodes due to ease of placement. However, electrodes may be placed directly into apertures communicating with fluidic channels.

The instrument can further comprise subsystems to operate the fluidic device. These can include a power subsystem to provide power to other subsystems. Another subsystem can be an electrical subsystem. The electrical subsystem can comprise a voltage source to impose a voltage difference across the various electrodes, including, electrical connections with the electrodes. Another subsystem can be a pneumatic subsystem. The pneumatic subsystem can comprise a source of positive and/or negative pneumatic pressure that can be applied to the pneumatic ports through pneumatic channels that communicate with the pressure source.

The instrument can further comprise sensors. For example, the instrument can comprise a temperature sensor. The temperature sensor can be configured and arranged to detect a temperature change in an elution channel, e.g., the channel between the elution reservoir 1505 and capillary barrier E of FIG. 2. The instrument can further include a light sensor, such as an infrared sensor, configured and arranged to detect temperature changes in the ITP channel, for example, at position C in FIG. 2. The instrument can further the computer comprising code programmed to alter voltage or current in the system based on feedback from either or both of the temperature sensor and the light sensor.

The system can comprise software comprising scripts to run ITP protocols, including operation of pneumatic force to load liquid into channels, control of voltage or current to perform ITP, changes in current or voltage in response to sensors to “hand-off” sample from the ITP circuit to the elution circuit, and to cease current or voltage after a time when sample is expected to move into an elution well.

III. Exemplary Method of Performing Isotachophoresis Using a Fluidic Device of this Disclosure
A. Creation of an Electrically Conductive Fluidic Circuit in a Device of this Disclosure

Aqueous solutions slow down or stop at capillary barriers due to increased surface tension. Inclusion of detergents in aqueous solutions reduces the surface tension and allows the water to spread more easily in the fluidic channel.

Referring to FIG. 1, an exemplary fluidic circuit can be loaded for ITP as follows. First, the chip is configured such that the sample port 1507 is sealed. Appropriate buffers are then introduced into buffer reservoirs. For example, trailing electrolyte (“TE”) buffer is added to reservoir 1503. Higher ionic strength leading electrolyte (“LEH”) buffer is introduced into reservoir 1502. Leading electrolyte (“LE”) buffer is introduced into reservoir 1506. Higher ionic strength elution (“EH”) buffer is introduced into reservoir 1501. Elution (“EE”) buffer is introduced into reservoir 1505. To the extent the buffers can spread through the channels, they will be arrested at the ramps of the capillary barriers.

The buffers are primed in the fluidic circuit by application of vacuum at pneumatic ports I and II. This action pulls the buffers into position as follows: Trailing electrolyte is pulled toward and arrested at the cliff of cliff capillary barrier A. LE buffer is pulled toward and arrested at the cliff of cliff capillary barrier B.

The seal on sample reservoir 1507 is removed. Sample liquid is introduced into the sample reservoir. Sample liquid typically comprises a detergent, which lowers the surface tension of the liquid. As a result, sample liquid spreads under its own force through the sample channel and up the ramp side of cliff capillary barriers A and B. Because the barriers are unable to arrest the flow of the sample fluid, the sample fluid makes fluid contact with the trailing electrolyte buffer and the leading electrolyte buffer.

Application of vacuum at pneumatic port III pulls the relevant buffers up the ramps of the notch capillary barriers. The force is sufficient to exceed the burst pressure of the notch capillary barriers. This puts the buffers on either side of the notch capillary barriers into fluid contact. So, more specifically, LEH buffer is put into liquid contact with LE buffer at notch capillary barrier D, EH buffer is put into liquid contact with EE buffer at notch capillary barrier F, and LE buffer is put into contact with EE buffer at notch capillary barrier E. This creates two fluidic circuits across which voltage can be applied, namely, between TE H reservoir 1503 and LEH reservoir 1502; and TE H reservoir 1503 and EH reservoir 1501.

### B. Performance of Isotachophoresis

After the fluidic circuits are established, isotachophoresis can proceed.

Referring to FIG. 2 and FIG. 3, a voltage is established between the leading electrolyte reservoir 1502 and trailing electrolyte reservoir 1503. Analyte, such as nucleic acids, e.g., DNA or RNA, or proteins, have an electric mobility in the system which is less than that of the leading electrolyte ion in greater than that of the trailing electrolyte ion. As a consequence analyte molecules become focused between the boundaries of the leading electrolyte ions in the trailing electrolyte ions. In certain embodiments, the fluidic device comprises parallel, independent fluidic circuits. In this case the movement of the analyte each circuit can be coordinated using feedback from the sensors that indicate the position of the analyte. After analyte reaches, for example, position C in the fluidic circuit, charge across electrodes in reservoirs 1502 and 1503 can be stopped and voltage across reservoirs 1501 and 1503 can be started. This operation can be referred to as a “handoff” operation between two branches of the circuit. The elution buffer has a lower concentration of ions then the leading electrolyte buffer. This difference allows for easier extraction of analyte from the buffer was collected. When sensors in the elution channel, e.g., at position 1504, detect the presence of analyte, it can signal a control mechanism in the instrument to allow voltage to continue for a set period of time known to be sufficient for analytes to accumulate in elution well 1505. Then, voltage is stopped. Analyte can now be withdrawn from elution well 1505, for example, by pipetting it out of the well. Analyte can then be subject to analysis or manipulation as desired by the operator.

### EXAMPLES

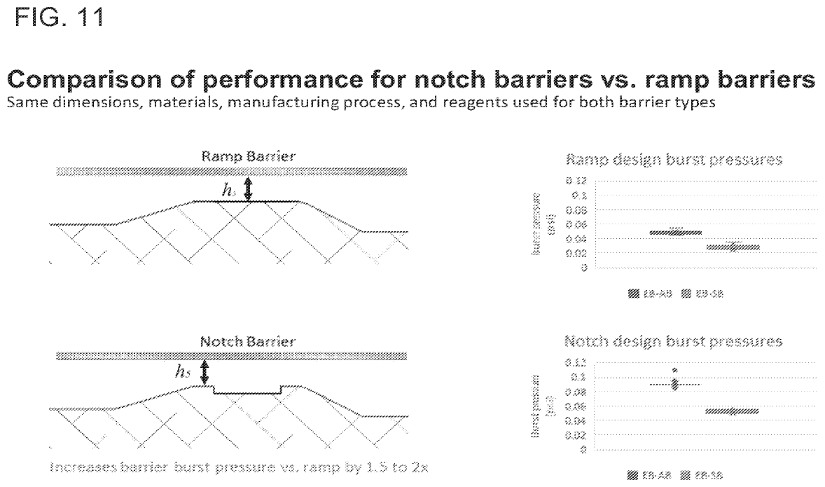

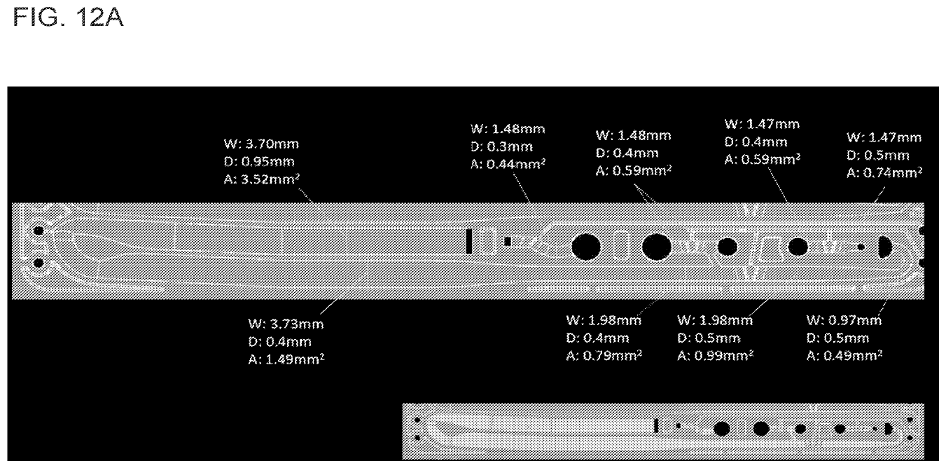

In this experiment (as shown in FIG. 11), burst pressures for notch capillary barriers vs. ramp barriers were compared. In this experiment, predefined volumes of ITP buffers were pipetted into a chip. Incrementally higher vacuum was applied at the pneumatic interface of the chip to draw the ITP buffers into the fluidic channels and onto the barriers. A camera system was used to capture video of the ITP buffers filling the fluidic channels as vacuum was applied. Image analysis software was used to determine the pressure at which fluidic barriers burst. Burst is defined as the two fluids being pulled across the barrier and connecting with each other. The burst pressure was recorded for each fluidic barrier and averaged for each barrier type (EB-AB, EB-SB, SB-NB, etc.) of which there are 8 on a chip (as shown in FIG. 1). As used herein, each barrier is named as an abbreviation of the two ITP buffers that are connected there. For example, Elution Buffer (EB) and Anodic Buffer (AB) are connected at the EB-AB interface. Elution Buffer (EB) and Separation Buffer (SB) are connected at the EB-SB interface. Notch capillary barriers with different names are designed specifically for a buffer pairing and have dimensions tailored accordingly. In this example, the gap (h₅) between the top of the plateau and the opposing wall (as shown in FIG. 11) was larger (e.g., 50%) on the EB-SB interface than the EB-AB interface to establish a deterministic burst order.

In this notch capillary barrier experiment, the gap (h₅) between the top of the plateau and the opposing wall also referred to as “height” of the barrier) of the EB-SB interface was about 150 μm, while the gap (h₅) between the top of the plateau and the opposing wall of the EB-AB interface was about 100 μm. Also in this notch capillary barrier experiment, the burst pressure at EB-AB interface was about 0.09 psi, while the burst pressure at EB-SB interface was about 0.055 psi. In comparison, in the ramp barrier, the burst pressure at EB-AB interface (having the same height as the EB-AB interface in the notch barrier) was about 0.045 psi, and burst pressure at EB-SB interface (having the same height as the EB-SB interface in the notch barrier) was about 0.025 psi in the ramp barrier. Thus, the average burst pressure in the notch capillary barrier was 1.5 to 2 times higher compared to that of the ramp barrier.

TABLE 1
Comparison between notch barrier
and ramp barrier burst pressures.

| | EB-SB Interface | | EB-AB Interface | |
|---|---|---|---|---|
| Gap (h5) between the top of | 150 | μm | 100 | μm |
| the plateau and the opposing | | | | |
| wall | | | | |
| Burst pressure in notch | 0.055 | psi | 0.09 | psi |
| barrier | | | | |
| Burst pressure in ramp | 0.025 | psi | 0.045 | psi |
| barrier | | | | |

Data from this experiment suggest the optimal heights in notch capillary barriers ranged from 100 μm to 150 μm, while the resulting burst pressures were from about 90 mpsi to about 50 mpsi, respectively. When the notch capillary barrier was higher than 400 μm, burst pressure was lower or equal to 10 mpsi, which is too low to precisely control the burst pressures. When the notch capillary barrier was lower than 50 μm, the burst pressure increased significantly, making the barriers too stronger for the current chip design where the surface tensions ranging from about 62 to about 70 mN/m. As a reference, water's surface tension is about 72 mN/m, which is the maximum value. Lower notch capillary barriers (e.g., lower than about 50 μm) can be valuable if using more wetting fluids (i.e., having lower surface energy). However, the lower limit on size can become a practical limitation of manufacturability and pressure control system, although the barrier height can theoretically go down to about 10 μm (or less). Since the average burst pressures in notch capillary barrier are higher, more wetting fluids than normal can be used in notch capillary barrier, for example, having a surface tension down to about 50 mN/m.

The buffers used in the notch capillary barrier experiment are Tris-Chloride ranging from about 10 mM to about 100 mM. Note that this concentration can be higher or lower since the ionic strength doesn't directly impact the function of the chips. A variety of surfactants can be used to decrease surface tension, for example, Tween®-80 (polyoxyethylene sorbitan monooleate), Tween®-20 (polyoxyethylene sorbitan monolaurate), Pluronic™ (e.g., Pluronic™ F-68), IGEPAL® CA-630 (octylphenoxypolyethoxyethanol), and Brij™ non-ionic surfactants (e.g., Brij™ 35: CH₃(CH₂)₁₁(OCH₂CH₂)₂₃OH). It is contemplated other types of surfactants can be used as well, since a surface tension (e.g., about 60-70 mN/m) that is compatible with the chips can be generally obtained by titration. Note that these values were obtained using chip material cyclic olefin copolymer (COC). While other materials could be used, the range of compatible surface tensions would likely change depending on the contact angle of the fluid with the chip material.

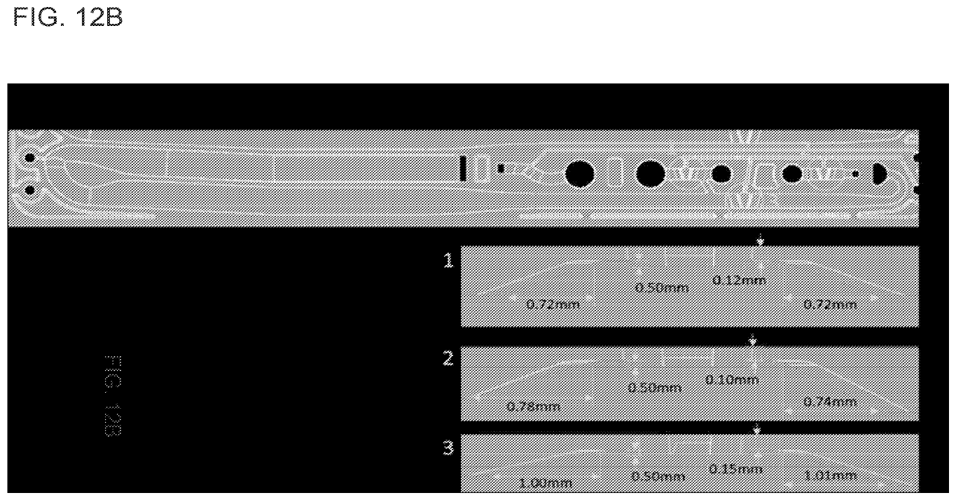

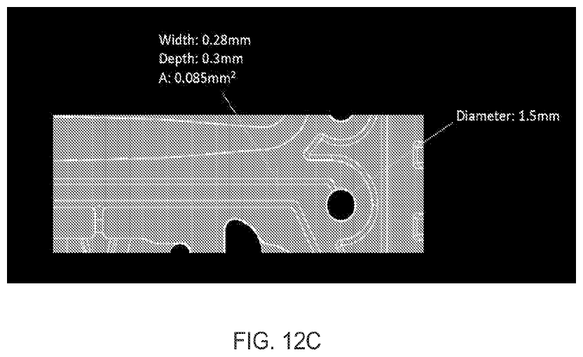

In FIG. 12A and FIG. 12B, a fluidic device has multiple channels and capillary barriers having different dimensions. In this non-limiting example (FIG. 12A), the fluidic device has channels having different sizes and cross-sectional areas. For example, one of the channels in the fluidic device has a width about 3.7 mm, a height about 0.95 mm, and cross-sectional area about 3.5 mm². One of the channels in the fluidic device has a width about 3.7 mm, height about 0.4 mm, and cross-sectional area about 1.5 mm². One of the channels in the fluidic device has a width about 1.5 mm, height about 0.3 mm, and cross-sectional area about 0.4 mm². One of the channels in the fluidic device has width about 1.5 mm, height about 0.5 mm, and cross-sectional area about 0.74 mm². One of the channels in the fluidic device has a width about 2 mm, height about 0.5 mm, and cross-sectional area about 1 mm². One of the channels in the fluidic device has a width about 2 mm, height about 0.4 mm, and cross-sectional area about 0.8 mm². One of the channels in the fluidic device has a width about 1 mm, height about 0.5 mm, and cross-sectional area about 0.5 mm². In FIG. 12B, the fluidic device has three notch barriers having different dimensions. One of the notch barriers has two ramps (the “run” is about 0.72 mm in both ramps), a notch depth about 0.5 mm, and a barrier height about 0.12 mm. One of the notch barriers has two ramps (the “run” is about 0.78 mm in one ramp, and about 0.74 mm in the other ramp), a notch depth about 0.5 mm, and a barrier height about 0.1 mm. One of the notch barriers two ramps (the “run” is about 1 mm in one ramp, and 1.01 mm in the other ramp), a notch depth about 0.5 mm, and a barrier height about 0.15 mm.

FIG. 12C shows a non-limiting example of a gas line in a fluidic device, where the width is about 0.28 mm, depth is about 0.3 mm, and cross-sectional area is about 0.085 mm². The port where the gas line terminates has a diameter about 1.5 mm.

### EXEMPLARY EMBODIMENTS

1. A fluidic device comprising a notch capillary barrier or an inset barrier disposed in a fluidic channel comprising, wherein:
   the notch capillary barrier comprises a first ramp and a second ramp, wherein the first and second ramps rise in opposite directions within the fluidic channel, and a notch positioned between the first and second ramps, wherein the notch comprises a base and two opposing faces; and
   the inset barrier comprises first and second base sections within the fluidic channel, and a notch positioned between the first and second base sections, wherein the notch comprises a notch base and two opposing faces.
2. The fluidic device of embodiment 1, wherein the fluidic channel at the base of the first ramp has a cross-sectional area between about 30 μm and 50 μm.
3. The fluidic device of embodiment 1, wherein the first ramp and/or the second ramp have a rise-over-run between 0.4 and 0.9.
4. The fluidic device of embodiment 1, wherein the rise-over-run of the first ramp is greater than the rise-over-run of the second ramp.
5. The fluidic device of embodiment 1, wherein the first ramp and/or the second ramp are configured as an angled plane.
6. The fluidic device of embodiment 1, wherein the first ramp and/or the second ramp are curved.
7. The fluidic device of embodiment 1, wherein the notch capillary barrier comprises a cross-sectional area in a longitudinal axis of the channel of triangular shape comprising a notch.
8. The fluidic device of embodiment 1, wherein the notch capillary barrier comprises a plateau between the first ramp and the second ramp, and the notch is located within the plateau.
9. The fluidic device of embodiment 1, wherein the capillary barrier extends transversely across the width of the fluidic channel.
10. The fluidic device of embodiment 1, wherein the base of the notch is positioned higher than a base of the channel.
11. The fluidic device of embodiment 1, wherein each notch forms an edge with one of the ramps or a plateau positioned between the ramps, wherein the edge is straight.
12. The fluidic device of embodiment 1, wherein each notch forms an edge with one of the ramps or a plateau positioned between the ramps, wherein the edge is curved.
13. The fluidic device of embodiment 12, wherein the curve is convex relative to the ramp.
14. The fluidic device of any of embodiments 11-13, wherein the edges are parallel or oblique with respect to each other.
15. The fluidic device of embodiment 1, wherein the faces of the notch are oriented in a Z dimension and notch comprises an expansion of a wall of the channel in an X-Y plane.
16. The fluidic device of embodiment 1, wherein the notch has a depth from an edge of about 0.05 mm.
17. The fluidic device of embodiment 1, wherein the space between the channel wall and the notch base is about 0.15 mm.
18. The fluidic device of embodiment 1, wherein the angle of the first ramp is about 10 degrees, at least about 15 degrees, or at least about 20 degrees steeper than the angle of the second ramp.
19. The fluidic device of embodiment 1, wherein the first ramp has an angle of about 28.9°.
20. The fluidic device of embodiment 1, wherein one or both of the notch faces are configured as a flat plane.
21. The fluidic device of embodiment 1, wherein one or both notch faces are configured as a curved plane.
22. The fluidic device of embodiment 1, wherein the plateau, when present, is about parallel to a base of the fluidic channel.
23. The fluidic device of embodiment 1, wherein the notch faces, notch base and channel walls define a notch space, and the fluidic device comprises a gas line communicating between a pneumatic port and a port opening into the notch space.
24. The fluidic device of embodiment 23, wherein the fluidic channel comprises a plurality of notch capillary barriers, and wherein a single pneumatic port communicates through a plurality of gas lines with ports opening into each of the notch spaces.
25. The fluidic device of embodiment 1, wherein the notch of the inset barrier has a depth between about 30 μm and 50 μm.
26. The fluidic device of embodiment 1, wherein faces of the inset barrier have different heights.
27. A fluidic device comprising a fluidic circuit comprising:
   a) a trailing electrolyte reservoir;
   b) a sample channel communicating with the trailing electrolyte reservoir and, positioned between them, a first cliff capillary barrier, wherein a face of the first cliff capillary barrier faces the trailing electrolyte reservoir;
   c) an isotachophoresis (“ITP”) channel communicating with the sample channel and, positioned between them, a second cliff capillary barrier, wherein a face of the second capillary barrier faces the sample channel;
   d) a first circuit branch communicating with the ITP channel and comprising a leading electrolyte reservoir and a higher ionic strength leading electrolyte reservoir, and positioned between them, a first notch capillary barrier.
28. The fluidic device of embodiment 27, further comprising:
   e) a second circuit branch, comprising (i) an elution channel communicating with the ITP channel, and positioned between them, a second notch capillary barrier, (ii) an elution buffer reservoir communicating with the elution channel and communicating with a higher ionic strength elution buffer reservoir, and positioned between them, a third notch capillary barrier.
29. The fluidic device of embodiment 27 or embodiment 28, further comprising one or more pneumatic ports communicating through one or more gas lines with ports opening onto spaces defined by the notch.
30. The fluidic device of embodiment 29, further comprising one or more pneumatic ports each communicating with a cliff capillary barrier through a gas line opening into a space adjacent to the cliff face of the cliff capillary barrier.
31. The fluidic device of embodiment 27 or embodiment 28, further comprising a sample well positioned over the sample channel and communicating through a bore therewith.
32. The fluidic device of embodiment 27 or embodiment 28, wherein the sample channel communicates with a sample reservoir positioned over the sample channel.
33. The fluidic device of embodiment 32, wherein the sample reservoir comprises (a) an entryway for ambient air at one end and (b) an aperture that penetrates said substrate at another end of said loading reservoir, wherein said first reservoir has a frustoconical shape with a wider region of said frustoconical shape positioned at said entryway for ambient air and a narrower region positioned at said first aperture that penetrates said substrate.
34. The fluidic device of embodiment 32, wherein the sample reservoir is closed by a removable material.
35. The fluidic device of any of embodiments 27-30, comprising a plurality, e.g., eight, of the fluidic circuits.
36. The fluidic device of embodiment 34, wherein the reservoirs of the fluidic circuits are aligned with wells of 96-well plate having dimensions about 127.76 mm×about 85.48 mm.
37. The fluidic device of embodiment 27 or embodiment 28, comprising:
   (i) a first substrate having a first face and a second face, wherein said first face comprises the reservoirs configured as hollow tubes that create a through hole between the first face and the second face, and the second face comprises the gas lines and the channels configured as grooves in the second face, and the capillary barriers configured as raised elements within the groups including said first channel; and
   (ii) a second substrate bonded to the second phase of the first substrate where in the second substrate closes the reservoirs, the gas lines in the channels.
38. The fluidic device of embodiment 37, further comprising a cover plate covering the first face of the first substrate.
39. The fluidic device of embodiment 38, further comprising a gasket sandwiched between the cover letter and the first substrate.
40. The fluidic device of embodiment 38 or 39, further comprising a hydrophobic membrane sandwiched between the cover layer and the first substrate, optionally between the cover layer in the gasket, wherein the hydrophobic membrane and the gasket cover the pneumatic ports.
41. The fluidic device of embodiment 37, wherein the first substrate comprises a plastic, e.g., FTPE.
42. A system comprising:
   a) an instrument comprising:
      i) a cartridge interface configured to engage a fluidic device, and comprising: (I) a plurality of electrodes, each electrode configured to be positioned within a buffer reservoir in an engaged fluidic device, and (II) a plurality of pneumatic ports, each pneumatic port configured to engage a pneumatic port in an engaged fluidic device;
      ii) a voltage source communicating with the plurality of electrodes, and configured to apply a voltage difference between the electrodes; and
      iii) a source of positive and/or negative pressure communicating with the pneumatic ports; and
   b) a fluidic device of embodiment 27 or embodiment 28, engaged with the cartridge interface.
43. The system of embodiment 34, wherein the fluidic device is loaded with:
   i) a trailing electrolyte buffer (“TE”) solution in the trailing electrolyte reservoir,
   ii) a leading electrolyte buffer (“LE”) solution in a leading electrolyte reservoir, wherein leading electrolyte ions in the LE solution have greater mobility than trailing electrolyte ions in the TE;
   iii) a higher ionic strength leading electrolyte buffer (“LEH”) solution in the higher concentration leading electrolyte buffer reservoir, wherein the LEH solution has a higher ionic strength than the LE solution;
   iv) an elution buffer (“EE”) solution in the elution reservoir, wherein leading electrolyte ions in the EE solution are present at a lower concentration than in the LE solution; and
   v) a higher ionic strength elution buffer (“EH”) solution in the higher ionic strength elution buffer reservoir, wherein leading electrolyte ion in the EH solution is present at a higher concentration than in the EE solution;
   vi) a sample solution into the sample channel.
44. The system of embodiment 34, wherein the instrument further comprises:
   iv) a temperature sensor configured to measure temperature in a fluidic channel of an engaged fluidic device.
45. The system of embodiment 34, wherein the instrument further comprises:
   iv) an infrared temperature sensor configured to measure temperature in a fluidic channel of an engaged fluidic device.
46. A method of fluidically connecting a first liquid and a second liquid in a fluidic circuit of a fluidic device, comprising:
   a) providing a fluidic device comprising a fluidic circuit comprising a first reservoir and a second reservoir communicating through a fluidic channel, and, positioned in the fluidic channel, a notch capillary barrier or an inset capillary barrier;
   b) providing a first liquid to the first reservoir and a second liquid to the second reservoir; and
   c) applying positive or negative pressure to the fluidic channel in excess of the burst pressure of the notch capillary barrier, and sufficient to fluidically connect the first liquid and the second liquid.
47. The method of embodiment 46, wherein the pressure comprises vacuum pressure.
48. The method of embodiment 46, wherein the fluidic device further comprises a pneumatic ports communicating through one or more gas lines with ports opening onto spaces defined by the notch, and the vacuum pressure is applied through the pneumatic port.
49. A method of fluidically connecting fluids in a fluidic circuit, comprising:
   a) providing a fluidic device of embodiment 28;
   b) loading fluids into the fluidic device by:
      i) introducing a trailing electrolyte buffer (“TE”) solution into the trailing electrolyte reservoir,
      ii) introducing a leading electrolyte buffer (“LE”) solution into a leading electrolyte reservoir, wherein leading electrolyte ions in the LE solution have greater mobility than trailing electrolyte ions in the TE;
      iii) introducing a higher ionic strength leading electrolyte buffer (“LEH”) solution into the higher concentration leading electrolyte buffer reservoir, wherein the LEH solution has a higher ionic strength than the LE solution;
      iv) introducing an elution buffer (“EE”) solution into the elution reservoir, wherein leading electrolyte ions in the EE solution are present at a lower concentration than in the LE solution; and
      v) introducing a higher ionic strength elution buffer (“EH”) solution into the higher ionic strength elution buffer reservoir, wherein leading electrolyte ion in the EH solution is present at a higher concentration than in the EE solution;
   c) applying positive or negative pressure at the first and second cliff capillary barriers to arrest TE solution at the first cliff capillary barrier, and to arrest LE solution at the second cliff capillary barrier;
   d) introducing a sample solution into the sample channel, wherein the sample solution has sufficiently low surface tension to allow the sample solution to create liquid contact the TE solution at the first cliff capillary barrier, and the LE solution at the second cliff capillary barrier; and
   e) applying vacuum pressure at the first, second and third notch capillary barriers sufficient to overcome the burst pressures of the first, second, and third notch capillary barriers, wherein i) the LEH solution and the LE solution, ii) the EE solution and the LE solution, and the EE solution and the EH solution are put into liquid contact with each other at the first, second, and third notch capillary barriers respectively.
50. The method of embodiment 49, wherein the pressure comprises vacuum.
51. The method of embodiment 49, further comprising:
   f) introducing an electrode into one or more of the reservoirs.
52. The method of embodiment 50, further comprising:
   g) applying a voltage or current across said first electrode and second electrode.
53. The method of embodiment 52, further comprising:
   h) inserting a third electrode into second elution buffer in said second elution buffer reservoir; and, after operation (h), applying a voltage or current across said first and third electrode, and, optionally, reducing current of said second electrode.
54. The method of embodiments 52 or 53, wherein an electrode in the trailing electrolyte reservoir is an anode, and the electrodes in the leading electrolyte reservoir and/or elution electrolyte reservoir is/are cathodes.

As used herein, the following meanings apply unless otherwise specified. The word “may” is used in a permissive sense (i.e., meaning having the potential to), rather than the mandatory sense (i.e., meaning must). The words “include”, “including”, and “includes” and the like mean including, but not limited to. The singular forms “a,” “an,” and “the” include plural referents. Thus, for example, reference to “an element” includes a combination of two or more elements, notwithstanding use of other terms and phrases for one or more elements, such as “one or more.” The phrase “at least one” includes “one”, “one or more”, “one or a plurality” and “a plurality”. The term “or” is, unless indicated otherwise, non-exclusive, i.e., encompassing both “and” and “or.” The term “any of” between a modifier and a sequence means that the modifier modifies each member of the sequence. So, for example, the phrase “at least any of 1, 2 or 3” means “at least 1, at least 2 or at least 3”. The term “consisting essentially of” refers to the inclusion of recited elements and other elements that do not materially affect the basic and novel characteristics of a claimed combination.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

1. A fluidic device comprising a notch capillary barrier or an inset barrier disposed in a fluidic channel, wherein:
the notch capillary barrier comprises a first ramp and a second ramp, wherein the first and second ramps rise in opposite directions within the fluidic channel, and a notch positioned between the first and second ramps, wherein the notch comprises a base and two opposing faces; and
the inset barrier comprises first and second base sections within the fluidic channel, and a notch positioned between the first and second base sections, wherein the notch comprises a notch base and two opposing faces.

2-5. (canceled)

6. The fluidic device of claim 1, wherein the rise-over-run of the first ramp is greater than the rise-over-run of the second ramp.

7. The fluidic device of claim 1, wherein the first ramp and/or the second ramp are configured as an angled plane.

8. The fluidic device of claim 1, wherein the first ramp and/or the second ramp are curved.

9. The fluidic device of claim 1, wherein the notch capillary barrier comprises a cross-sectional area in a longitudinal axis of the channel of triangular shape comprising a notch.

10. The fluidic device of claim 1, wherein the notch capillary barrier comprises a plateau between the first ramp and the second ramp, and the notch is located within the plateau.

11. The fluidic device of claim 1, wherein the capillary barrier extends transversely across the width of the fluidic channel.

12. The fluidic device of claim 1, wherein the base of the notch is positioned higher than a base of the channel.

13. The fluidic device of claim 1, wherein each notch forms an edge with one of the ramps or a plateau positioned between the ramps, wherein the edge is straight.

14. The fluidic device of claim 1, wherein each notch forms an edge with one of the ramps or a plateau positioned between the ramps, wherein the edge is curved.

15. The fluidic device of claim 14, wherein the curve is convex relative to the ramp.

16. The fluidic device of claim 13, wherein the edges are parallel or oblique with respect to each other.

17. The fluidic device of claim 1, wherein the faces of the notch are oriented in a Z dimension and notch comprises an expansion of a wall of the channel in an X-Y plane.

18-21. (canceled)

22. The fluidic device of claim 1, wherein one or both of the notch faces are configured as a flat plane.

23. The fluidic device of claim 1, wherein one or both notch faces are configured as a curved plane.

24. The fluidic device of claim 1, wherein the plateau, when present, is about parallel to a base of the fluidic channel.

25. The fluidic device of claim 1, wherein the notch faces, notch base and channel walls define a notch space, and the fluidic device comprises a gas line communicating between a pneumatic port and a port opening into the notch space.

26-29. (canceled)

30. The fluidic device of claim 1, wherein the notch or inset capillary barrier comprises a buffer comprising a surfactant.

31-33. (canceled)

34. The fluidic device of claim 1, wherein the faces of the inset barrier have different heights.

35. The fluidic device of claim 1, further comprising a gas line communicating between a pneumatic port and a port opening into a notch/inset space in the notch/inset barrier.

36-72. (canceled)
